(19) United States
(12) Patent Application Publication
(10) Pub. No.: US 2026/0304462 A1
(43) Pub. Date: Oct. 1, 2026

(54) METHOD AND USER EQUIPMENT

(71) Applicant: NEC Corporation, Tokyo (JP)

(72) Inventors: Xuelong WANG, Guildford (GB); Pravjyot DEOGUN, Milton Keynes (GB); Yuhua CHEN, London (GB)

(73) Assignee: NEC Corporation, Tokyo (JP)

(21) Appl. No.: 19/477,231

(22) PCT Filed: May 2, 2024
(86) PCT No.: PCT/JP2024/016916

§ 371 Date: Oct. 21, 2025

(30) Foreign Application Priority Data
May 11, 2023 (GB) 2307042.8

(51) Int. Cl. H04W 72/40; H04L 1/1812; H04W 72/02; H04W 72/0446; H04W 72/566

(52) U.S. Cl. CPC H04W 72/40; H04L 1/1812; H04W 72/02; H04W 72/0446; H04W 72/566

(57) ABSTRACT

The present disclosure relates to a method performed by a first mobile device, and the method includes: determining whether a data unit is not transmitted in any of resources for the data unit that are associated with a process of sidelink communication between the first mobile device and a second mobile device for multiple consecutive time resources transmission due to listen before talk (LBT) failure; and in a case where the data unit is not transmitted in any of resources for the data unit that are associated with the process of sidelink communication between the first mobile device and the second mobile device for the multiple consecutive time resources transmission, triggering a selection procedure of resources for the data unit that are associated with the process of sidelink communication for the multiple consecutive time resources transmission, based on a highest priority of a corresponding logical channel.

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to data transmission over multiple consecutive slots for sidelink.

Earlier developments of the 3GPP standards were referred to as the Long-Term Evolution (LTE) of Evolved Packet Core (EPC) network and Evolved UMTS Terrestrial Radio Access Network (E-UTRAN), also commonly referred as ‘4G’. More recently, the term ‘5G’ and ‘new radio’ (NR) has started to be used to refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, and gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term access network node, RAN node or base station to refer to any such access nodes.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

In the current 5G architecture, the gNB structure may be split into two or more parts. In some RAN implementations there are two parts, known as the Central Unit (CU or gNB-CU)—sometimes referred to as a ‘control unit’- and the Distributed Unit (DU or gNB-DU), connected by an F1 interface. This enables the use of a ‘split’ architecture in which the typically ‘higher’ CU layers (for example, but not necessarily or exclusively, Packet Data Convergence Protocol (PDCP) and Radio Resource Control (RRC) layers) and the, ‘lower’ DU layers (for example, but not necessarily or exclusively, Radio Link Control (RLC), Media (or ‘Medium’) Access Control (MAC), and Physical (PHY) layers) are separated between a particular CU, and one or more DUs that are connected to and controlled by that CU via the F1 interface. Thus, for example, the higher layer CU functionality for a number of gNBs may be implemented centrally (for example, by a single processing unit, or in a cloud-based or virtualised system), whilst retaining the lower layer DU functionality locally separately for each gNB.

Current communication technology also provides various ways in which UEs can communicate data between each other directly without using resources of a base station (although in some cases the UEs will require at least some control signalling from the base station). Such communications are often referred to as UE-to-UE direct communications, Device-to-Device (D2D) communications or sidelink communications. D2D communications were originally defined as part of Proximity Services (ProSe) services in Release 12 and Release 13 of the 3GPP specifications. As part of ProSe services, a new D2D interface was introduced. This D2D interface is referred to as ‘PC5’, or ‘Sidelink’ at the physical layer. Sidelink provides a direct link for communications between devices, with or without network coverage. As D2D technology has been developed, sidelink has been further enhanced for vehicular use cases, addressing high speed (up to 250 km/h along roads and up to 500 km/h along railways) and high density (thousands of nodes) scenarios as well.

Sidelink has several application areas/use cases, such as proximity services, public safety, IoT, including machine type communication and sensors, wearable devices, amongst others. The term Vehicle-to-Everything (V2X) covers a special application area of Sidelink/PC5 for the purpose of communications between vehicles using a direct link. V2X encompasses at least the following categories: Vehicle-to-Vehicle (V2V); Vehicle-to-Infrastructure (V2I); Vehicle-to-Pedestrian (V2P); Vehicle-to-Home (V2H); and enhanced Vehicle-to-Everything (eV2X).

As sidelink communication involves direct communication between UEs, it supports a range of use cases in which a UE is not necessarily within coverage of a base station. These use cases include: in-coverage use cases in which a given pair of UEs involved in sidelink communication are both in coverage of the base station, partial-coverage use cases in which one of the UEs involved in the sidelink communication is in coverage of the base station while another of the UEs involved in the sidelink communication is not in coverage of the base station; and out-of-coverage use cases in which neither of a given pair of UEs involved in sidelink communication are in coverage of the base station. Of course, a given UE may move between in-coverage, partial coverage, and out-of-coverage scenarios.

Sidelink communication between UEs uses physical channels that are analogous to corresponding physical channels used for communication between the base station and a UE. These sidelink physical channels include the Physical Sidelink Broadcast Channel (PSBCH), the Physical Sidelink Feedback Channel (PSFCH), the Physical Sidelink Shared Channel (PSSCH), and the Physical Sidelink Control Channel (PSCCH). Control information for controlling sidelink communication, referred to as sidelink control information (SCI), may be sent directly between UEs. SCI is sent in two parts (referred to as ‘stages’). The 1st stage is carried by a PSCCH and the 2nd stage is carried by a corresponding PSSCH, which is associated with the PSCCH.

When a UE is in-coverage of a base station, the base station is able to assign and manage the resources used for sidelink communications (e.g., V2V communications or the like), from that UE to another UE, using base station to UE communication over the air interface (e.g., the so-called Uu interface). In NR this network managed type of resource allocation is known as mode 1 resource allocation, although it is similar a type of resource allocation known as mode 3 in LTE (for V2X). In the network-controlled resource allocation sidelink radio resources can be allocated from sidelink dedicated licensed carriers or from licensed carriers that share resources between the UE-UE sidelink and the UE-base station uplink. In NR, scheduling for the network-controlled resource allocation mode (mode 1) may involve dynamic grant (DG) scheduling (as in LTE V2X mode 3 scheduling) or configured grant (CG) scheduling (whereas LTE V2X mode 3 uses semi-persistent scheduling (SPS)).

In the DG scheduling, a UE respectively requests resources from the base station for the transmission each transport block (TB) (and for each possible blind or hybrid automatic repeat request (HARQ) retransmission). Specifically, the UE transmits a scheduling request (SR) to the base station in the uplink using a physical uplink control channel (PUCCH). The base station responds with downlink control information (DCI), using a physical downlink control channel (PDCCH), that indicates the allocated sidelink resources (e.g., time resources in the form of one or more slots and frequency resources in the form of one or more sub-channels). The allocated sidelink resources may be used for the transmission of the TB and up to two possible retransmissions of the same TB. Accordingly, while DG scheduling provides a high resource scheduling flexibility, and a relatively low latency, the need to request resources nevertheless introduces some delay and increases signalling overhead.

In CG scheduling, the base station assigns a set of sidelink resources (referred to as the configured grant (CG)) to a UE that can be used (persistently or semi-persistently) for transmitting several TBs. The CG is configured using a set of parameters that includes a CG index, at least one time-frequency allocation, and the periodicity of the allocated SL resources. To support CG scheduling, the UE may provide the base station with UE assistance information. Accordingly, CG scheduling has the potential to provide a reduced signalling overhead and latency compared to DG, albeit at the expense of resource scheduling flexibility.

When a UE is out-of-coverage of any base station, the network is unable to assign and manage the resources used for sidelink communications. To allow sidelink communication by UE that is out-of-coverage, therefore, the UE can apply an autonomous resource selection technique (a distributed scheduling protocol in which the resource allocation is effectively carried out by the UEs themselves). In NR this autonomous type of resource selection is known as mode 2 (or ‘NR V2X Mode 2’) resource allocation, although it is similar a type of resource allocation known as mode 4 in LTE (for V2X). Specifically, when operating in the autonomous resource selection mode, a UE can autonomously select sidelink resources (one or several sub-channels) from within a resource pool that may be preconfigured and/or configured by the base station when the UE is in network coverage. NR autonomous mode (mode 2) resource allocation supports a dynamic scheduling scheme and a semi-persistent scheduling (SPS) scheme. When using the dynamic scheme the UE selects new resources for each TB and can only reserve resources (by notifying in-range UEs) for future retransmissions of that TB. The semi-persistent scheme can be enabled, or disabled, in a given resource pool by a (pre)configuration. When a UE reserves a resource for future transmission it notifies nearby (‘neighbouring’) UEs using 1st stage SCI that is sent directly from one UE to another using a physical sidelink control channel (PSCCH). When using the SPS scheme a UE can select and reserve resources for the transmission of several TBs (and their retransmissions).

In the autonomous mode (mode 2), a UE can select new sidelink resources when it generates a new TB. Selection can also be triggered for the SPS scheme when a new TB is too large to be sent in previously reserved resources. To select new sidelink resources (either dynamic or semi-persistent), a UE initially defines a time interval (corresponding to a range of slots), referred to as a selection window, including resources (referred to as candidate resources) from which new sidelink resources are selected for transmission of a TB.

When the UE is not transmitting, it performs a sensing operation to identify candidate resources that are available. The sensing operation is performed during a time interval, referred to as a sensing window, corresponding to range of slots. During the sensing process, the UE decodes 1st stage SCI received from other UEs in the sensed sidelink resources. The respective 1st-stage SCI received from each UE indicates the sidelink resources reserved for retransmissions of a TB associated with the 1st-stage SCI, and resources reserved for the initial transmission and retransmissions of the next TB. The UE also measures the transmissions (e.g., reference signal received power (RSRP)) associated with respective 1st stage SCI received from other UEs. The UE stores the sensed information (the decoded 1st stage SCI and the RSRP measurements) and determines, based on the sensed information, which candidate resources from the selection window should be excluded when a new selection is triggered (and hence those candidate resources that are available for selection).

Autonomous mode (mode 2) sensing-based SPS may be used, for example, for periodic traffic. In particular, sensing based SPS UEs may reserve resources (sub-channels) in the frequency domain for a random number of consecutive periodic transmissions in the time domain. The set of selected slots in which resources are reserved are then repeated periodically with a configured period known as the resource reservation period. The transmitting UE will include information indicating this reservation period within the 1st stage SCI sent to other UEs to allow the other UEs to estimate which resources may be reserved in the future. The number of slots for transmission (and retransmissions) within each periodic resource reservation period will depend on the number of blind retransmissions (if any) and the resource selection procedure. The number of reserved subchannels per slot will depend on the size of data to be transmitted. After using the reserved resources for a configured number of transmissions (equal to a parameter referred to as a ‘Sidelink Resource Reselection Counter (SLRRC)) the UE determines whether the same selection should be kept, or whether a new resource selection procedure should be triggered, based on a pre-configured probability value known as the “probability of resource keep”.

Sidelink radio resources can be configured so that network controlled (mode 1) resource allocation and autonomous (mode 2) resource selection use different resource pools. However, sidelink radio resources can also be configured so that network controlled (mode 1) resource allocation and autonomous (mode 2) resource allocation share the same resource pool. Pool sharing has the benefit of potentially greater resource efficiency albeit at the expense of conflict (e.g., potential collisions) between transmissions scheduled using the different modes. To address this, a UE operating in network-controlled resource allocation mode notify other, autonomous resource selection mode UEs, of the resources allocated for their future (re)transmissions, for example using the 1st stage SCI that is sent directly from one UE to another using the PSCCH as described above.

Sidelink communication (e.g., for NR V2X) supports Hybrid Automatic Receive reQuest (HARQ) procedures for improving the reliability of the sidelink communication. HARQ procedures are, for example, supported for unicast and groupcast messages which can provide more reliability for these traffic types.

HARQ operates at both MAC and PHY layers. Retransmissions occur at the MAC layer, whereas the PHY layer (at the receiver) combines one or more transmissions to increase the chances of correct decoding.

Sidelink HARQ feedback (i.e., comprising acknowledgements (ACKs) and/or negative acknowledgements (NACKs)) is provided on the PSFCH and may be in the form of ACK/NACK based feedback, or NACK-only feedback. ACK/NACK based feedback is sent on the PSFCH, based on the success or failure in the reception of the whole transport block (i.e., an ACK or a NACK respectively) using a resource dedicated to a single PSFCH transmitting UE. NACK-only feedback is provided, by a UE, on the PSFCH when reception at that UE is unsuccessful—no signal is sent, by that UE, on the PSFCH when reception is successful. NACK-only feedback is particularly useful for groupcast/broadcast services because it reduces the number of resources needed when a high number of receiver UEs exist and need to send feedback at the same time. NACK-only feedback can, for example, be provided on a resource that can be shared by multiple PSFCH transmitting UEs.

In addition to feedback-based retransmissions, the possibility of blind retransmissions has been introduced (for which explicit feedback is not required from the receiving UE). Blind and feedback-based retransmissions may be used for unicast and groupcast communications, while for broadcast communications only blind retransmissions are currently supported.

For blind retransmissions, HARQ is, in effect, implemented only at the receiver for retransmission combining. The transmitting UE chooses the resources, within the resource reservation period, to be used for retransmission. The transmitting UE will preform a number of retransmissions, based on a configured value, up to a maximum number of retransmissions of 31 (i.e., 32 transmissions in total). Blind retransmissions can, nevertheless, be resource inefficient (especially if the initial transmission is successful).

For feedback-based retransmissions, HARQ is, in effect, implemented both at the transmitter for efficient retransmissions, and at the receiver for retransmission combining. Whilst feedback-based retransmissions are, in general, more resource efficient (because the transmitting UE only needs resources for retransmission if the original transmission is NACKed), blind retransmissions have the potential to reduce the latency associated with feedback-based retransmissions because the transmitting UE does not need to wait for HARQ feedback before sending a retransmission.

### CITATION LIST

### Non Patent Literature

NPL 1: “Channel Access Mechanism for Sidelink on Unlicensed Spectrum”, 3GPP DRAFT, vol 3GPP RAN 1, 2023, PETER GALL ET AL, available from http://www.3gpp.org/ftp/TSG_RAN/WG1_RL1/TSGR1_112/Docs/R1-2301413.zip
NPL 2: “Discussion on cannel access mechanism”, 3GPP DRAFT, vol RAN WG1, 2023 MEDIATEC INC, available from https://ftp.3gpp.org/tsg_ran/WG1_RL1/TSGR1_112b-e/Docs/R1-2303367.zip
NPL 3: “On channel access mechanism and resource allocation for SL-U”, 3GPP DRAFT, vol RAN WG1, 2023, OPPO, available from https:ftp.3gpp.org/tsg_ran/WG1_RL1/RSGR1_112b-e/Docs/R1-2302549.zip
NPL 4: The ‘NGMN 5G White Paper’ V1.0 by the Next Generation Mobile Networks (NGMN) Alliance, available from https://www.ngmn.org/5g-white-paper.html.

### SUMMARY OF INVENTION

### Technical Problem

As part of the development of sidelink communication technology, work is being done to provide support for sidelink communication over unlicensed spectrum (SL-U). This typically requires the use of an appropriate channel access mechanism to ensure that different devices that use the unlicensed coexist with one another fairly and comply with local regulatory requirements regarding the use of such spectrum.

One such channel access mechanism is ‘listen-before-talk’ (LBT) in which transmitting devices (UE/base station) are typically expected to perform some form of clear channel assessment (CCA) involving “sensing” the medium to detect any transmissions from other nodes before acquiring, if the channel is clear/available, a channel occupancy time (COT) within which to transmitting. The CCA may, for example, involve energy detection (i.e., measuring the received energy level of any signals transmitted from other devices) and determining whether a channel is idle or busy based on the detected energy. There are different scenarios in which different LBT requirements are appropriate including some in which channel access can be performed immediately (without requiring a sensing/listening step).

To this end, four LBT categories are currently defined for (dynamic) channel access for NR communication in unlicensed bands:
Cat 4 LBT with a contention window (also known as ‘Type 1’)
Cat 2 LBT with a 25 μs gap (also known as ‘Type 2A’)
Cat 2 LBT with a 16 μs gap (T also known as ‘Type 2B’)
Cat 1 LBT with no more than a 16 μs gap, without performing channel sensing/LBT (also known as ‘Type 2C’)
   For uplink (UL)/downlink (DL) communication both a base station and a UE can acquire a COT with Cat 4 LBT, while the base station or the UE can share the COT acquired by the other node with Cat 2 or Cat 1 LBT under different conditions.

For sidelink (e.g., V2X) communication, therefore, a transmitting UE can access a channel on which one or more transmissions are to be performed, using an appropriate LBT channel access procedures, according to one of these Type 1 or Type 2 categories, to support operation over unlicensed spectrum. A Type 1 LBT channel access procedure would require the transmitting UE to perform regular channel sensing (as described by physical layer specification). For a Type 2A ‘UL’ channel access procedure, the transmitting UE may transmit the transmission immediately after sensing the channel to be idle for a sensing interval of at least 25 μs. For a Type 2B ‘UL’ channel access procedure, the transmitting UE may transmit the transmission immediately after sensing the channel to be idle for a sensing interval of at least 16 μs. For a Type 2C ‘UL’ channel access procedure, the UE may transmit the transmission without sensing the channel before the transmission. For a COT during which resources are shared, the UE is only required to perform a Type 2 LBT channel access procedure, and the UE does not, therefore, have to pass a Type 1 LBT check to use the resources of that channel.

It is currently envisaged that the existing sidelink autonomous mode (mode 2) resource allocation schemes will be supported as a baseline for resource allocation for SL-U. In this context the question arises as to whether sensing-based resource selection should be triggered before any LBT is triggered, or after any LBT is triggered.

Support is also being developed for sidelink communication in which transmission can occur over several consecutive slots (referred to as multiple consecutive slots transmission (MCSt)). In addition to having the potential to increase the capacity of sidelink transmission, motivations for developing MCSt include the potential to reduce the need and/or frequency for a UE to perform LBT to access a channel once it has acquired a COT, and the potential to retain the COT to transmit the UE's data as soon as possible (i.e., in the following slots). The guard symbol between adjacent slots of the MCSt can be such that there is either no gap, or the gap is no greater than 16 μs (i.e., corresponding to Type 2C/no LBT being needed) between the transmissions in adjacent slots.

In the autonomous mode (mode 2) resource selection procedure used for sidelink communication, a higher layer (e.g., MAC layer) of the transmitting UE provides a set of parameters in order to trigger the physical layer (layer 1/L1) to report a subset of candidate single-slot resources that can be selected for transmission. These parameters include, for example: a layer 1 (L1) priority (prio_TX); a (remaining) packet delay budget (PDB); number of sub-channels (L_“subCH”); and a reservation periodicity (P_“rsvp_TX”). The resources are then randomly selected, in the MAC layer, for the initial transmission and re-transmissions of a single TB. Accordingly, in the context of MCSt, there can be no guarantee that the selected resources can be and will be in consecutive slots.

Moreover, MCSt may support the transmission of multiple TBs (in addition to single TB transmission). Historically, in the case of multiple TB transmission, multiple sets of higher layer parameters may be provided to L1 for the candidate resource reporting (assuming that the higher layer is able to trigger the resource (re)selection process for multiple TBs at the same time).

For SL-U, in the context of MCSt operation, when L1 is triggered by a higher (MAC) layer for reporting a subset of candidate resources for MCSt, the question arises as to: whether only a single set of parameters (e.g., prio_TX, remaining PDB, L_“subCH” and P_“rsvp_TX”) should be provided by the higher (MAC) layer for the resource selection procedure in L1 (for transmission of a single TB or multiple TBs); or whether multiple sets of parameters (prio_TX, remaining PDB, L_“subCH” and P_“rsvp_TX”) may be provided for the resource selection procedure (e.g., for transmission of multiple TBs). While the possibility of multiple parameter sets provides flexibility, provision of a single parameter set has the advantage of reduced complexity.

Similarly, there are a number of possible options for L1 to report a subset of candidate resources for MCSt to the MAC layer (for resource reservation). L1 may, for example, report candidate multi-slot resources as a candidate resource set, S_{A}, where each candidate multi-slot resource respectively consists of a set of single-slot resources that are consecutive in time (in this case the question of whether the respective resources of a set of single-slot resources within a candidate multi-slot resource can have different L_“subCH” sizes also needs to be considered). Alternatively, L1 may report candidate single-slot resources in the candidate resource set, S_{A}, as for existing resource selection procedures (in this case it would be up to the higher (MAC) layer to select a set of single-slot resources that are in consecutive logical slots). Alternatively, L1 may report consecutive single-slot candidate resources in the candidate resource set, S_{A}.

In physical layer, the enhancements in autonomous mode (mode 2) resource selection for MCSt are mainly related to the selection of time and frequency resources in consecutive slots.

In a similar manner to license assisted access (LAA) for using unlicensed spectrum in earlier releases, for NR communication over unlicensed spectrum (NR-U) a respective channel access priority class (CAPC) can be configured for each data radio bearer (DRB). Signalling radio bearers (SRBs)—which carry control signals such as RRC and non-access stratum (NAS) messages—always (with the exception of SRB2) use the highest priority CAPC. A base station will typically assign a CAPC for a DRB by taking into account the 5G QoS identifiers (5QIs) of all the QoS flows multiplexed in that DRB, while considering the fairness between different traffic types and transmissions. A specific, standardised, CAPC may be used for a QoS flow having a 5QI forming part of a standardised set 5QIs to which the specific CAPC is mapped. A QoS flow corresponding to a non-standardised 5QI (e.g., an operator specific 5QI) may use the CAPC of the standardised 5QI which best matches the QoS characteristics of the non-standardised 5QI. The UE can use this configuration to determine a CAPC when not explicitly signalled by the base station directly. This applies to all CG transmissions and some dynamic grants, where the UE selects the lowest priority CAPC among the multiplexed data flows. The exception is when signalling data is transmitted in which case the CAPC of the associated packet is same as the CAPC of the highest priority signalling bearer.

For SL-U a similar procedure is used to determine a CAPC for a sidelink DRB SL-DRB) or sidelink SRB (SL-SRB). Specifically a so-called PC5 QoS identifier (PQI), which is a special 5QI, may be used to determine the CAPC mapping in a manner similar to that described for NR-U described above. For an SL-DRB, a CAPC value is (pre)configurable per-DRB as for NR-U. For all SL-SRBs, a CAPC value is fixed to the highest priority (i.e., lowest CAPC value). For all SL MAC control elements (CEs), a CAPC value is fixed to the highest priority (i.e., lowest CAPC value). For PQI-based CAPC mapping, at least the PDB (and possibly other parameters) can be used as a criterion to determine the CAPC. Moreover, as in NR-U for non-standardised PQI, the CAPC of the standardised PQI which best matches the QoS characteristics of the non-standardized PQI may be used (as a baseline).

A UE will determine the CAPC of a sidelink TB when the CAPC is not indicated in the DCI. If only one or more SL MAC CEs are included in the sidelink TB, the highest priority sidelink CAPC will be used. If sidelink control channel (SCCH) service data units (SDUs) are included in the sidelink TB, then the highest priority sidelink CAPC will be used.

Whilst work on MCSt for sidelink communication is ongoing, there are a number of areas that would benefit from further development to provide improved UEs and related methods/apparatus where appropriate, especially in (but not limited to) the context of SL-U. For example, one or more detailed mechanisms that should take place at the physical layer for MCSt is still not clear. One or more mechanisms that should take place at the MAC layer, and coordination between the physical and MAC layers have also not been considered in any detail.

For example, whilst for single slot resource-based transmission, the UE triggers a resource (re)selection when PSSCH transmission was not performed due to an LBT failure indication from L1. However, this type of LBT failure handling is not appropriate for MCSt because if an LBT failure occurs for the first slot, the UE may still be able try an additional LBT in the following slots within a MCSt slot group.

Moreover, there is a risk that an MCSt transmission may block lower CAPC level (i.e., higher priority) data.

There are, therefore, several areas for possible development/improvement including, but are not limited to: the resource selection procedure for MCSt; HARQ operation for MCSt; LBT procedures (e.g., failure handling) for MCSt; and/or logical channel prioritization and CAPC assignment in the context for MCSt.

### Solution to Problem

The disclosure aims to provide apparatus and related methods aimed at contributing, at least partially, to addressing the above issues/needs.

In one aspect there is provided, a method performed by a first user equipment (UE), the method comprising: providing, from a first protocol layer to a second protocol layer, information for use in selecting resources for transmission of data using direct UE-to-UE communication in a plurality of consecutive time resources; receiving, at the first protocol layer from the second protocol layer, information indicating a set of candidate resources, selected based on the information, for the direct UE-to-UE communication in the plurality of consecutive time resources; and transmitting the data to a second UE via direct UE-to-UE communication, using at least a subset of the candidate resources, in the plurality of consecutive time resources; wherein the information includes at least one of: at least one parameter associated with an autonomous mode of resource selection wherein, in a case where the data includes respective data from each of a plurality of different data sources, each parameter of the at least one parameter is respectively based on a corresponding attribute associated with data from one data source of the plurality of different data sources; transmission pattern information identifying at least one intended transmission pattern for transmission of the data via direct UE-to-UE communication; and/or size information indicating an estimated total size of data to be transmitted, wherein the estimated total size is based both on an initial transmission of the data and any intended retransmission of the data.

In the case where the information includes at least one parameter, the at least one parameter may include a priority parameter indicating a second protocol layer priority. In the case where the data includes respective data from each of a plurality of different data sources, the priority parameter may indicate the second protocol layer priority is based on a corresponding priority related attribute associated with data from a data source, of the plurality of different data sources, for which an associated priority is highest. The corresponding priority related attribute associated with data from a data source may be a channel access priority class (CAPC) and the priority parameter may be based on the CAPC associated with the data source, of the plurality of different data sources, for which the associated CAPC is lowest.

In the case where the information includes at least one parameter, the at least one parameter may include a packet delay budget (PDB) parameter indicating a remaining PDB. In the case where the data includes respective data from each of a plurality of different data sources, the PDB parameter may be based on a corresponding PDB related attribute associated with data from a data source, of the plurality of different data sources, for which a remaining PDB is lowest.

In the case where the data includes respective data from each of a plurality of different data sources, the plurality of data sources may include at least one direct UE-to-UE media access control (MAC) control element (CE). In the case where the data includes respective data from each of a plurality of different data sources, the plurality of data sources may include at least one direct UE-to-UE logical channel (LCH).

In the case where the data includes more data than can be transmitted using the set of candidate resources, the method may further comprise the first protocol layer triggering the second protocol layer to perform a further selection of resources for transmission of at least some of the data. In the case where the set of candidate resources includes more resources than are necessary for transmission of the data, the method may further comprise dropping at least a subset of resources that are not required for transmission of the data. In the case where the set of candidate resources includes more resources than are necessary for transmission of the data, the method may further comprise performing a logical channel prioritisation (LCP) procedure for further transmission of the data, or further data, to at least one further UE via direct UE-to-UE communication, using at least a subset of resources that are not required for transmission of the data to the second UE.

In the case where the information includes transmission pattern information, the transmission pattern information may includes at least one of: an indication of a number of transport blocks (TBs) for transmission of the data; an indication of a hybrid automatic repeat request (HARQ) transmission mechanism; and/or a number of slots to be occupied for blind retransmission.

In the case where the transmission pattern information includes an indication of the HARQ transmission mechanism, indication of the HARQ transmission mechanism may indicates at least one of: whether the HARQ transmission mechanism is feedback based or blind retransmission based; a number of the direct UE-to-UE HARQ processes to be used for intended HARQ transmission; and/or a number of blind retransmissions for at least one TB.

The data may be transmitted to the second UE, in a plurality of different transport blocks (TBs), using a common hybrid automatic repeat request (HARQ) process, and each TB may be transmitted using a different respective time resource of the plurality of consecutive time resources.

The data may be transmitted to the second UE, in at least one transport block (TB), using a common hybrid automatic repeat request (HARQ) process, and the at least one TB may be transmitted using more than one time resource of the plurality of consecutive time resources.

The data may be transmitted to the second UE, in at least one transport block (TB), using a common hybrid automatic repeat request (HARQ) process, and the at least one TB may be transmitted in a first time resource of the plurality of consecutive time resources and then retransmitted in at least one further time resource of the plurality of consecutive time resources.

The method may further comprise providing, from the first protocol layer to the second protocol layer, an indication of at least one of a redundancy version, and/or time resources to be used, for transmission and/or each retransmission of the TB.

The data may be transmitted to the second UE, in a single transport block (TB), using a hybrid automatic repeat request (HARQ) process, and the single TB may be transmitted using at least one time resource of the plurality of consecutive time resources.

The method may further comprise receiving at least one of HARQ feedback and/or a data transmission, from the second UE, in at least one other time resource of the plurality of consecutive time resources. The at least one other time resource may form at least part of a shared channel occupancy time (COT). The method may further comprise transmitting to the second UE, COT sharing information indicating the at least one other time resource. The data may be transmitted to the second UE, in a plurality of transport blocks (TBs), and each TB may be transmitted using a different respective hybrid automatic repeat request (HARQ) process. Each TB may be respectively transmitted in a different time resource of the plurality of consecutive time resources. Each TB may respectively carry data having the same priority. The data may be transmitted using a feedback based HARQ retransmission mechanism. The data may be transmitted using a blind retransmission based HARQ retransmission mechanism, and each TB may be respectively retransmitted in a different time resource of the plurality of consecutive time resources.

A first TB of the plurality of TBs may be transmitted and blindly retransmitted in the plurality of consecutive time resources, in an interleaved manner with transmission and blind retransmission of a second TB of the plurality of TBs. A first TB of the plurality of TBs may be transmitted and blindly retransmitted in consecutive time resources of the plurality of consecutive time resources, and a second TB of the plurality of TBs may be transmitted and blindly retransmitted in consecutive time resources of the plurality of consecutive time resources.

The first protocol layer may be a media access control (MAC) layer. The second protocol layer may be a physical (PHY/L1) layer.

In one aspect there is provided, a method performed by a first user equipment (UE), the method comprising: receiving, at a first protocol layer from a second protocol layer, information indicating a set of candidate resources for transmission of data using direct UE-to-UE communication in a plurality of consecutive time resources; and transmitting the data to a second UE via direct UE-to-UE communication, using at least a subset of the candidate resources, in the plurality of consecutive time resources; wherein, in the case where the data includes more data than can be transmitted using the set of candidate resources, the first protocol layer triggers the second protocol layer to perform a further selection of resources for transmission of at least some of the data; and wherein, in the case where the set of candidate resources includes more resources than are necessary for transmission of the data, the method further comprises: dropping at least a subset of resources that are not required for transmission of the data; and/or performing a logical channel prioritisation (LCP) procedure for further transmission of the data, or further data, to at least one further UE via direct UE-to-UE communication, using at least a subset of resources that are not required for transmission of the data to the second UE.

The at least one further UE may be selected as at least one destination UE for the further transmission regardless of whether or not a priority associated with the at least one further UE is higher than a priority associated with another potential destination UE.

In one aspect there is provided, method performed by a first user equipment (UE), the method comprising: receiving, at a first protocol layer from a second protocol layer, information indicating a set of candidate resources for transmission of data using direct UE-to-UE communication in a plurality of consecutive time resources; performing a respective listen-before-talk (LBT) for each time resource of the plurality of consecutive time resources in turn until: a result of an LBT, for a corresponding time resource of the plurality of consecutive time resources, indicates transmission of the data can start in that corresponding time resource; or the respective LBT fails in every time resource of the plurality of consecutive time resources; and in a case where at least one LBT fails for a corresponding time resource of the plurality of consecutive time resources, providing at least one LBT failure indication from the second protocol layer to the first protocol layer; wherein the at least one LBT failure indication comprises: a single LBT failure indication that is provided in a case that the respective LBT fails in every time resource of the plurality of consecutive time resources; a respective LBT failure indication that is provided for each LBT that fails for a corresponding time resource of the plurality of consecutive time resources; or an LBT failure indication that identifies at least one time resource of the plurality of consecutive time resources for which LBT has failed.

On receipt of the at least one LBT failure indication from the second protocol layer, the first protocol layer may adapt a planned transmission or retransmission of the data based on the at least one LBT failure indication from the second protocol layer.

In one aspect there is provided, method performed by a first user equipment (UE), the method comprising: receiving, at a first protocol layer from a second protocol layer, information indicating a set of candidate resources for transmission of existing data using direct UE-to-UE communication in a plurality of consecutive time resources; and transmitting the existing data to a second UE via direct UE-to-UE communication, in at least one transport block (TB), using at least a subset of the candidate resources, in the plurality of consecutive time resources; wherein, in a case where the existing data includes a plurality of different data each different data having a different respective priority level of a plurality of possible priority levels: the plurality of different data having the different priority levels is included in the at least one TB regardless of whether the same TB includes different data having different respective priority levels; the plurality of different data having the different priority levels is included in a plurality of TBs in a manner that ensures that each TB includes data having a common priority level; or the plurality of different data having the different priority levels is included in the at least one TB in a manner that ensures that each TB only includes data having a priority level within a specific range of priority levels.

In a case where a plurality of different data having the different priority levels is included in the at least one TB regardless of whether the same TB includes different data having different respective priority levels, and the UE has new data for transmission before transmission of all the existing data has completed, the UE may wait to transmit the new data, until the existing data has been transmitted, regardless of whether or not the new data has a higher priority level than the existing data.

In a case where a plurality of different data having the different priority levels is included in the plurality of TBs in a manner that ensures that each TB includes data having a common priority level, and the UE has new data for transmission before transmission of all the existing data has completed, the UE may delay transmission of at least one untransmitted TB including existing data that has a lower priority level than the new data, and may transmit the new data in preference to that at least one untransmitted TB.

In a case where a plurality of different data having the different priority levels is included in the at least one TB in a manner that ensures that each TB only includes data having a priority level within the specific range of priority levels, and the UE has new data that has a higher priority level than specific range of priority levels for transmission before transmission of all the existing data has completed, the UE may delay transmission of at least one untransmitted TB including existing data that has a priority level within the specific range of priority levels, and may transmit the new data in preference to that to that at least one untransmitted TB.

Each priority level may be associated with a different respective channel access priority class (CAPC), and a lower CAPC corresponds to a higher priority level.

In one aspect there is provided, first user equipment (UE) comprising: means for providing, from a first protocol layer to a second protocol layer, information for use in selecting resources for transmission of data using direct UE-to-UE communication in a plurality of consecutive time resources; means for receiving, at the first protocol layer from the second protocol layer, information indicating a set of candidate resources, selected based on the information, for the direct UE-to-UE communication in the plurality of consecutive time resources; and means for transmitting the data to a second UE via direct UE-to-UE communication, using at least a subset of the candidate resources, in the plurality of consecutive time resources; wherein the information includes at least one of: at least one parameter associated with an autonomous mode of resource selection wherein, in a case where the data includes respective data from each of a plurality of different data sources, each parameter of the at least one parameter is respectively based on a corresponding attribute associated with data from one data source of the plurality of different data sources; transmission pattern information identifying at least one intended transmission pattern for transmission of the data via direct UE-to-UE communication; and/or size information indicating an estimated total size of data to be transmitted, wherein the estimated total size is based both on an initial transmission of the data and any intended retransmission of the data.

In one aspect there is provided, first user equipment (UE) comprising: means for receiving, at a first protocol layer from a second protocol layer, information indicating a set of candidate resources for transmission of data using direct UE-to-UE communication in a plurality of consecutive time resources; and means for transmitting the data to a second UE via direct UE-to-UE communication, using at least a subset of the candidate resources, in the plurality of consecutive time resources; wherein the first protocol layer is configured to trigger, in the case where the data includes more data than can be transmitted using the set of candidate resources, the second protocol layer to perform a further selection of resources for transmission of at least some of the data; and wherein, in the case where the set of candidate resources includes more resources than are necessary for transmission of the data, the UE is further configured to: drop at least a subset of resources that are not required for transmission of the data; and/or perform a logical channel prioritisation (LCP) procedure for further transmission of the data, or further data, to at least one further UE via direct UE-to-UE communication, using at least a subset of resources that are not required for transmission of the data to the second UE.

In one aspect there is provided, first user equipment (UE) comprising: means for receiving, at a first protocol layer from a second protocol layer, information indicating a set of candidate resources for transmission of data using direct UE-to-UE communication in a plurality of consecutive time resources; means for performing a respective listen-before-talk (LBT) for each time resource of the plurality of consecutive time resources in turn until: a result of an LBT, for a corresponding time resource of the plurality of consecutive time resources, indicates transmission of the data can start in that corresponding time resource; or the respective LBT fails in every time resource of the plurality of consecutive time resources; and means for providing, in a case where at least one LBT fails for a corresponding time resource of the plurality of consecutive time resources, at least one LBT failure indication from the second protocol layer to the first protocol layer; wherein the at least one LBT failure indication comprises: a single LBT failure indication that is provided in a case that the respective LBT fails in every time resource of the plurality of consecutive time resources; a respective LBT failure indication that is provided for each LBT that fails for a corresponding time resource of the plurality of consecutive time resources; or an LBT failure indication that identifies at least one time resource of the plurality of consecutive time resources for which LBT has failed.

In one aspect there is provided, first user equipment (UE) comprising: means for receiving, at a first protocol layer from a second protocol layer, information indicating a set of candidate resources for transmission of existing data using direct UE-to-UE communication in a plurality of consecutive time resources; and means for transmitting the existing data to a second UE via direct UE-to-UE communication, in at least one transport block (TB), using at least a subset of the candidate resources, in the plurality of consecutive time resources; wherein, in a case where the existing data includes a plurality of different data each different data having a different respective priority level of a plurality of possible priority levels: the plurality of different data having the different priority levels is included in the at least one TB regardless of whether the same TB includes different data having different respective priority levels; the plurality of different data having the different priority levels is included in a plurality of TBs in a manner that ensures that each TB includes data having a common priority level; or the plurality of different data having the different priority levels is included in the at least one TB in a manner that ensures that each TB only includes data having a priority level within a specific range of priority levels.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 illustrates a typical configuration of a sidelink resource pool that may be used in the telecommunication system of FIG. 1;

FIG. 4A illustrates different types of slot format that may be used in the telecommunication system 1;

FIG. 4B illustrates different types of slot format that may be used in the telecommunication system 1;

FIG. 5 is a simplified sequence diagram illustrating an exemplary dynamic grant procedure that may be implemented in the telecommunication system of FIG. 1;

FIG. 6 is a simplified sequence diagram illustrating an exemplary configured grant procedure that may be implemented in the telecommunication system of FIG. 1;

FIG. 7 is a simplified illustration of how different CGs may be configured in the telecommunication system of FIG. 1;

FIG. 8 is a simplified illustration of how autonomous mode resource selection may operate in the telecommunication system of FIG. 1;

FIG. 9 is a simplified schematic block diagram illustrating the main components of a UE for the telecommunication system of FIG. 1;

FIG. 10 is a simplified schematic block diagram illustrating the main components of a base station for the telecommunication system of FIG. 1;

FIG. 11 is a simplified sequence diagram illustrating a procedure for autonomous MCSt resource selection that may be performed in the telecommunication system of FIG. 1;

FIG. 12 is a simplified sequence diagram illustrating a procedure that may be performed following autonomous selection of a candidate set of MCSt resources in the telecommunication system of FIG. 1;

FIG. 13 is a simplified sequence diagram illustrating a procedure for supporting autonomous MCSt resource selection, in the context of HARQ operation, that may be performed in the telecommunication system of FIG. 1;

FIG. 14 is a simplified diagram illustrating a number of different ways in which HARQ process based transmission, with HARQ feedback disabled, may take place in the telecommunication system of FIG. 1;

FIG. 15 is a simplified diagram illustrating another way in which HARQ process based transmission may take place in the telecommunication system of FIG. 1;

FIG. 16 is a simplified diagram illustrating another way in which HARQ process based transmission may take place in the telecommunication system of FIG. 1;

FIG. 17 is a simplified diagram illustrating another way in which HARQ process based transmission may take place in the telecommunication system of FIG. 1;

FIG. 18 is a simplified diagram illustrating another way in which HARQ process based transmission may take place in the telecommunication system of FIG. 1;

FIG. 19 is a simplified sequence diagram illustrating a number of different LBT failure handling mechanisms that may be used in the telecommunication system of FIG. 1;

FIG. 20 illustrates an example of how TB (re)transmission may be affected by one or more LBT failures within an MCSt slot group in the telecommunication system of FIG. 1; and

FIG. 21 illustrates another example of how TB (re)transmission may be affected by one or more LBT failures within an MCSt slot group in the telecommunication system of FIG. 1.

### DESCRIPTION OF EMBODIMENTS

### Overview

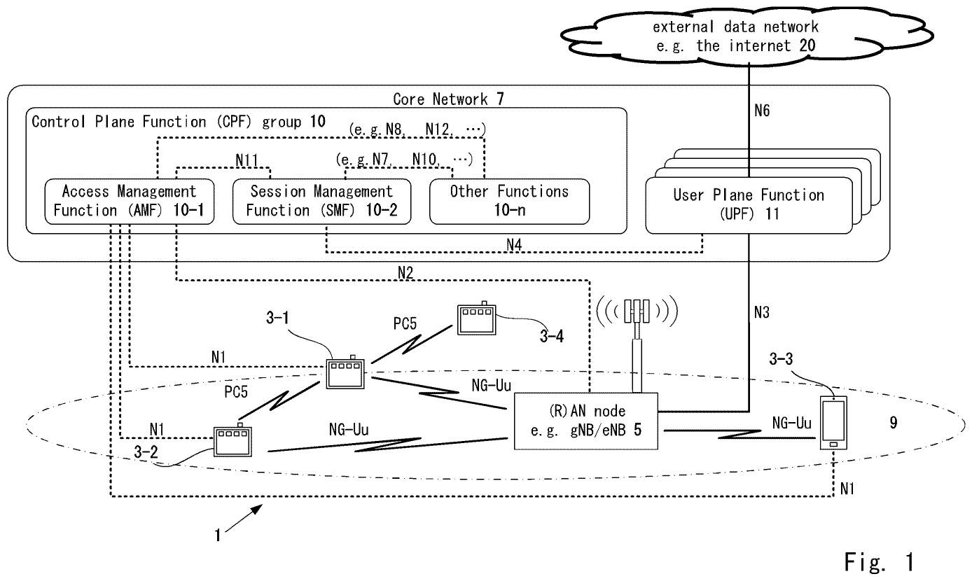

An exemplary telecommunication system will now be described in overview, by way of example only, with reference to FIGS. 1 to 8.

FIG. 1 schematically illustrates a mobile (‘cellular’ or ‘wireless’) communication system 1 to which example embodiments of the present disclosure are applicable.

In the communication system 1, user equipment (UEs) 3-1, 3-2, 3-3, 3-4 (e.g., mobile telephones and/or other mobile devices) can communicate with each other via a radio access network (RAN) node 5 that operates according to one or more compatible radio access technologies (RATs). In the illustrated example, the RAN node 5 comprises a base station 5 or ‘gNB’ 5 operating one or more associated cells 9. Communication via the base station 5 is typically routed through a core network 7 (e.g., a 5G/6G core network or evolved packet core network (EPC)).

As those skilled in the art will appreciate, whilst four UEs 3 and one base station 5 are shown in FIG. 1 for illustration purposes, the system, when implemented, will typically include other base stations and UEs.

Each base station 5 controls one or more associated cells either directly, or indirectly via one or more other nodes (such as home base stations, relays, remote radio heads, distributed units, transmission reception points (TRPs) and/or the like). It will be appreciated that the base stations 5 may be configured to support 4G, 5G and/or later generations, and/or any other 3GPP or non-3GPP communication protocols.

The UEs 3 and their serving base station 5 are connected via an appropriate air interface (for example the so-called ‘NG-Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more network node entities for the communication of user data (e.g. user plane functions (UPFs)) 11. The CPFs 10 include one or more network node entities for the communication of control signalling (e.g. Access and Mobility Management Functions (AMFs)) 10-1, one or more network node entities for session management (e.g. Session Management Functions (SMFs)) 10-2, and a number of other functions 10-n.

The base station 5 is connected to the core network nodes via appropriate interfaces (or ‘reference points’) such as a reference point (e.g. an N2 reference point) between the base station 5 and the AMF 10-1 for the communication of control signalling, and a reference point (e.g. an N3 reference point) between the base station 5 and each UPF 11 for the communication of user data. The UEs 3 are each connected to the AMF 10-1 via a (logical) non-access stratum (NAS) connection over a reference point (e.g. an N1 reference point) (analogous to the S1 reference point in LTE). It will be appreciated, that N1 communications are routed transparently via the base station 5.

One or more UPFs 11 are connected to an external data network (e.g., an IP network such as the internet) via a reference point (e.g. a N6 reference point) for communication of the user data.

The AMF 10-1 performs mobility management related functions, maintains the NAS connection with each UE 3 and manages UE registration. The AMF 10-1 is also responsible for managing paging. The SMF 10-2 is connected to the AMF 10-1 via a reference point (e.g. an N11 reference point). The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 is configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on the physical uplink shared channel PUSCH. The PBCH provides UEs 3 with the Master Information Block, MIB. It also, in conjunction with the PDCCH, supports the synchronisation of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), positioning reference signal (PRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, a physical uplink shared channel (PUSCH), a physical uplink control channel (PUCCH), and/or a physical random access channel (PRACH). The UL physical signals may include, for example, demodulation reference signals (DMRS) for a UL control/data signal, and/or sounding reference signals (SRS) used for UL channel measurement and/or measurements for UL positioning.

### Frame Structure

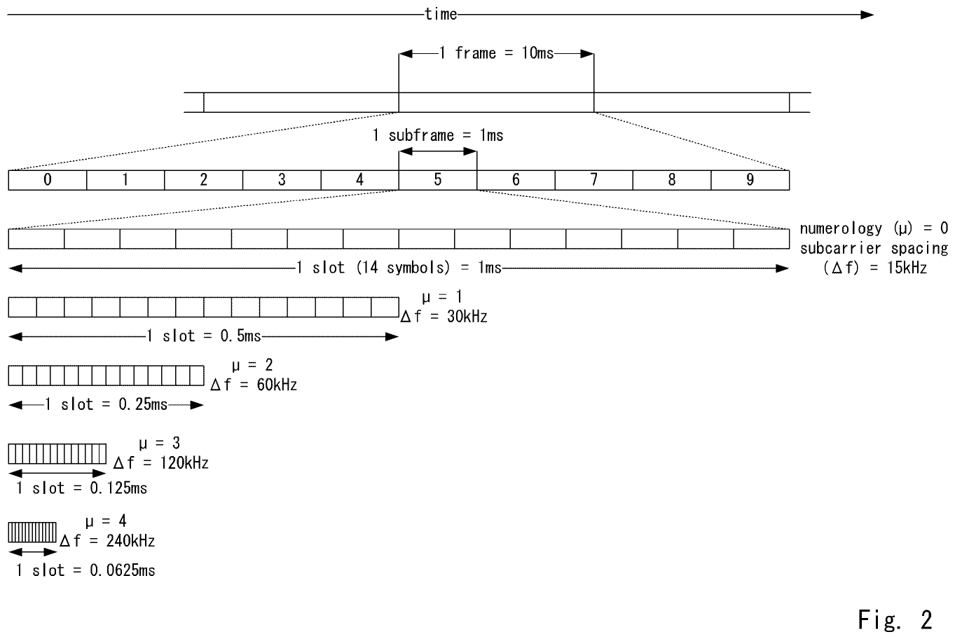

Referring to FIG. 2, which illustrates the typical frame structure that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e., SCS=15×2μ kHz). The relationship between the parameter, μ, and SCS (Δf) is as shown in Table 1:

TABLE 1
5G Numerology

| | | Number of slots per | |
|---|---|---|---|
| μ | Δf = 2^{μ} · 15[kHz] | subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### Bandwidth Parts

In the communication system 1 the cell bandwidth can be divided into multiple bandwidth parts (BWPs) that each start at a respective starting resource block (RB) and respectively comprises of a set of contiguous RBs with a given numerology (sub-carrier spacing, ‘SCS’, and cyclic prefix, ‘CP’) on a given carrier. By defining a small BWP for a UE 3, the computational complexity and power consumption of that UE 3 can be reduced. As each BWP can have a different bandwidth and numerology, BWPs enable flexible and efficient use of resources by dividing the carrier bandwidth for multiplexing transmissions with different configurations and requirements.

The UEs 3 and base station 5 of the communication system 1 are thus configured for operation using BWPs. For each serving cell of a UE 3, the base station 5 can configure at least one downlink (DL) BWP (e.g., an initial DL BWP). The base station 5 may configure the UE 3 with up to a maximum (typically four) further DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g., an initial UL BWP). The base station 5 may configure the UE 3 with up to a maximum (typically four) further UL BWPs with only one UL BWP being active at a given time. The UE 3 does not transmit PUSCH or PUCCH outside an active bandwidth part. For an active cell, the UE 3 does not transmit SRS outside an active bandwidth part.

A BWP identifier or index (BWP-ID) is used to refer to BWPs (in UL and DL independently). Various radio resource control (RRC) configuration procedures can thus use the BWP-ID to associate themselves with a particular BWP.

### General Support for Sidelink Communication

In the communication system 1, at least some of the UEs 3-1, 3-2, and 3-4 are capable of performing direct (UE-to-UE)—or ‘sidelink’—communication between one another, via a direct UE-to-UE interface (e.g., the ‘sidelink’ or ‘PC5’ interface) when in range. This direct communication may be: in-coverage sidelink communication involving a pair of UEs 3-1, 3-2 that are both in coverage of the base station 5 (e.g., as illustrated between UEs 3-2 and 3-1); partial-coverage sidelink communication involving a UE 3-1 that is in coverage of the base station 5 and a UE 3-4 that is not in coverage of the base station 5 (e.g., as illustrated between UEs 3-4 and 3-1); or out-of-coverage sidelink communication involving a pair of UEs 3-4 that are both outside the coverage of the base station 5.

The sidelink capable the UEs 3-1, 3-2, 3-4 are configured for communication via a number of dedicated sidelink physical channels and transmission/reception of a number of SL physical signals. The sidelink physical channels include the Physical Sidelink Broadcast Channel (PSBCH), the Physical Sidelink Feedback Channel (PSFCH), the Physical Sidelink Shared Channel (PSSCH), and the Physical Sidelink Control Channel (PSCCH).

The PSBCH carries the sidelink broadcast transport channel (SL-BCH) which is used for periodic transmission (e.g., every 160 ms) of a Master Information Block (MIB) for sidelink. The MIB carries system information for UE-to-UE communication. The information carried by the PSBCH is transmitted with a Sidelink Primary Synchronization Signal/Sidelink Secondary Synchronization Signal (S-PSS/SSS) as part of a sidelink-synchronization signal block (S-SSB).

The PSFCH is used for transmission of hybrid automatic repeat request (HARQ) feedback from a receiver UE 3-1, 3-2, 3-4 to a transmitter UE 3-1, 3-2, 3-4 on the SL, for example for a unicast or a groupcast communication. Blind retransmission is also supported by the UEs 3-1, 3-2, 3-4 for unicast, groupcast or broadcast communications.

The PSSCH contains transport blocks (i.e., user data traffic) of the sidelink shared transport channel (SL-SCH) and is typically associated with a PSCCH transmitted in the same slot.

The sidelink capable UEs 3-1, 3-2, 3-4 are able to send sidelink control information (SCI) in two stages for general sidelink communication. The 1st stage is carried by a PSCCH, and the 2nd stage is carried by a corresponding PSSCH, which is associated with the PSCCH.

A UE 3-1, 3-2, 3-4 may use the 1st stage SCI to inform other UEs 3-1, 3-2, 3-4 of resources allocated by the base station for a particular dynamic grant (DG)/configured grant (CG) period (e.g., in mode 1) or autonomously selected by the UE (e.g., in mode 2). A UE 3-1, 3-2, 3-4 may use the 2nd-stage SCI to inform other UEs 3-1, 3-2, 3-4 of information to be used for decoding the PSSCH, and for supporting HARQ feedback and CSI reporting.

The first-stage SCI may contain, for example, information to enable sensing operations, information about the resource allocation of the PSSCH, and, when needed, an indication that the UE can receive conflict information in inter-UE coordination. The 1st stage SCI typically includes, for example: a frequency resource (e.g., sub-channels) assignment for the PSSCH; a time resource assignment; a resource reservation period for up to two further transmissions an associated TB; a priority for the associated PSSCH; a demodulation reference signal (DMRS) pattern; information identifying a 2nd-stage SCI format and size; a modulation and coding scheme of the data payload carried in the associated PSSCH; one or more reserved bits; a beta offset indicator; and/or a number of a DMRS port.

The second-stage SCI can carry information needed to identify and decode the associated SL-SCH, as well as control for HARQ procedures, triggers for channel state information (CSI) feedback, inter-UE coordination requests and information, etc. The 2nd stage SCI typically includes, for example: a HARQ process ID; a new data indicator; a redundancy version; a source ID; a destination ID; and/or a CSI request.

### Resources for Sidelink Communication

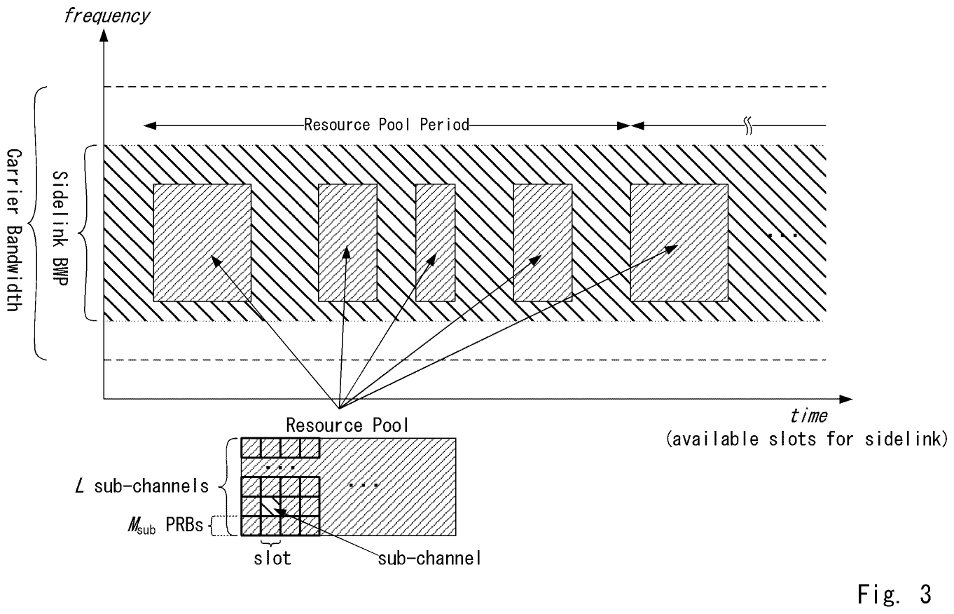

Referring to FIG. 3, which illustrates a typical configuration of a sidelink resource pool that may be used in the communication system of FIG. 1, the base station 5 is able to configure at least one respective dedicated sidelink BWP (SL-BWP) for each of the sidelink capable UEs 3-1, 3-2, 3-4. Each SL BWP occupies a contiguous portion of the bandwidth within the component carrier on which the cell 9 is provided. Sidelink transmissions and receptions for a given UE 3-1, 3-2, 3-4 will be contained within the SL BWP configured for that UE 3-1, 3-2, 3-4 and will employ the same numerology. Thus, all physical channels, reference signals and synchronization signals in the sidelink are transmitted within the corresponding SL BWP. This also means that, in the sidelink, a UE 3-1, 3-2, 3-4 is not expected to receive or to transmit using more than one numerology. The SL BWP is divided into common RBs where a common RB consists of 12 consecutive subcarriers with the same SCS, where the SCS is given by the numerology of the SL BWP.

The communication resources available for sidelink comprise time resources (e.g., sots) and frequency resources (e.g., common RBs) within a SL BWP. A subset of these available sidelink resources may be preconfigured/configured to be used by one or more UEs 3-1, 3-2, 3-4 for their sidelink communication (transmissions/receptions). This subset of available resources may be referred to as a ‘resource pool’.

A given UE 3-1, 3-2, 3-4 can be preconfigured/configured with a plurality of resource pools including one or more resource pools for transmission (TX resource pools) and with one or more resource pools for reception (RX resource pools). Accordingly, a UE 3-1, 3-2, 3-4 is able to receive data on resource pools used for SL transmissions by other UEs 3-1, 3-2, 3-4, while the UE 3-1, 3-2, 3-4 can still transmit on the sidelink using its transmit resource pools. A resource pool can be used for all transmission types (for example, unicast, groupcast, and/or broadcast).

The common resource blocks within a resource pool may also be referred to as physical resource blocks (PRBs). As seen in FIG. 3, the illustrated resource pool consists of contiguous PRBs and contiguous, or non-contiguous, slots that have been preconfigured/configured for sidelink communication. The resource pool is defined to be within the SL BWP and so a single numerology is used within the resource pool. If a UE 3-1, 3-2, 3-4 has been configured with an active UL BWP, then the SL BWP will also use the same numerology as the UL BWP if they both BWPs are on the same carrier.

The resource pool is divided, in the frequency domain, into a preconfigured/configured number (‘L’) of contiguous sub-channels (representing the smallest frequency unit for sidelink data transmission/reception), where each sub-channel comprises a group of consecutive PRBs in a slot. The size of the sub-channel (in units of PRBs) is given by ‘M_{sub}’ and may be preconfigured/configured to be any suitable size (for example, 10, 12, 15, 20, 25, 50, 75, or 100 PRBs). Each sidelink transmission may use one or multiple sub-channels.

In the time domain, the slots that are part of a resource pool are preconfigured/configured and occur with a pre-set periodicity corresponding to a resource pool period (the resource pool period is typically, for example, 10240 ms). The slots that form the resource pool may be preconfigured/configured, for example by means of a bitmap which may be any suitable length (for example 10, 11, 12, . . . , 160 bits).

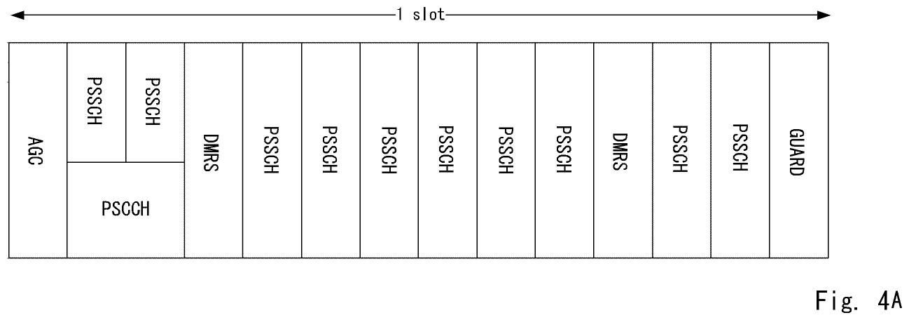

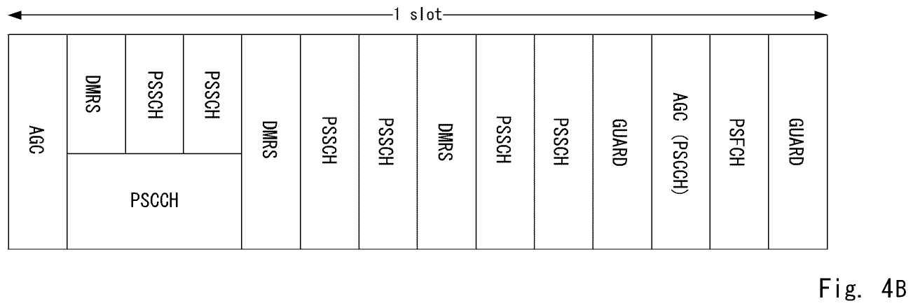

FIGS. 4A and 4B illustrate respectively different types of slot format that may be used in the communication system 1. As seen in FIGS. 4A and 4B, each slot can include PSSCH, PSCCH, PSFCH, automatic gain control (AGC) and guard symbols. The AGC and guard symbols are sent as specific symbols. AGC symbols may be used for level control in a sidelink receiver whereas guard symbols may be used as guard periods for switching between sidelink reception and transmission. Guard symbols are placed as immediate symbols after PSSCH, PSFCH, or S-SSB.

The PSSCH is transmitted in consecutive symbols of a slot. The start symbol and the number of symbols to transmit the PSSCH are configured by a higher layer, (e.g., a media access control (MAC) layer). A PSSCH cannot be transmitted in the same symbols that are configured for the transmission of PSFCH or the last symbol of the slot, which is configured as a place holder for a guard symbol.

### Network Managed Resource Allocation for Sidelink Communication

Each sidelink UE 3-1, 3-2, 3-4 and the base station 5 are mutually configured for operation in a network managed resource allocation mode (e.g., mode 1 resource allocation) resource allocation (e.g., when the UE 3-1, 3-2, 3-4 is in coverage of the base station 5). Scheduling in the network-controlled resource allocation mode may involve dynamic grant (DG) scheduling or may involve configured grant (CG) scheduling.

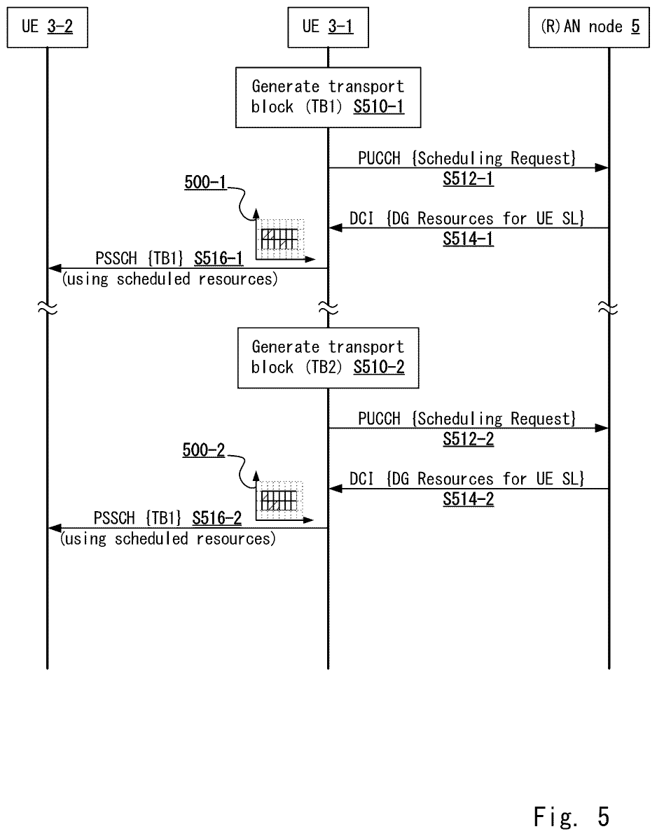

The network managed resource allocation mode will now be described, by way of example only, with reference to FIGS. 5 to 7.

FIG. 5 is a simplified sequence diagram illustrating an exemplary dynamic grant procedure that may be implemented in the communication system 1.

As seen in FIG. 5, in the illustrated example, dynamic grant is used for transmitting two TBs (TB1 and TB2). When the UE 3-1, 3-2, 3-4 generates a transport block (TB1) at S510-1, the UE 3-1, 3-2, 3-4 sends a scheduling request (e.g., on the PUCCH) to the base station 5 at S512-1 to request resources for transmitting TB1. The base station 5 responds, at S514-1 with downlink control information (DCI) indicating the resources 500-1 for the UE 3-1, 3-2, 3-4 to use for transmission of TB1 (and up to two possible retransmissions). The UE 3-1, 3-2, 3-4 can then use the scheduled resources 500-1, at S516-1, to transmit TB1 (e.g., using the PSSCH). A similar process takes place when another transport block (TB2) is generated at S510-2. Specifically, the UE 3-1, 3-2, 3-4 sends another scheduling request (e.g., on the PUCCH) to the base station 5 at S512-2 to request resources 500-2 for transmitting TB2. The base station 5 responds, at S514-2 with downlink control information indicating the resources 500-2 for the UE 3-1, 3-2, 3-4 to use for transmission of TB2 (and up to two possible retransmissions). The UE 3 can then use the scheduled resources 500-2, at S516-2, to transmit TB2 (e.g., using the PSSCH).

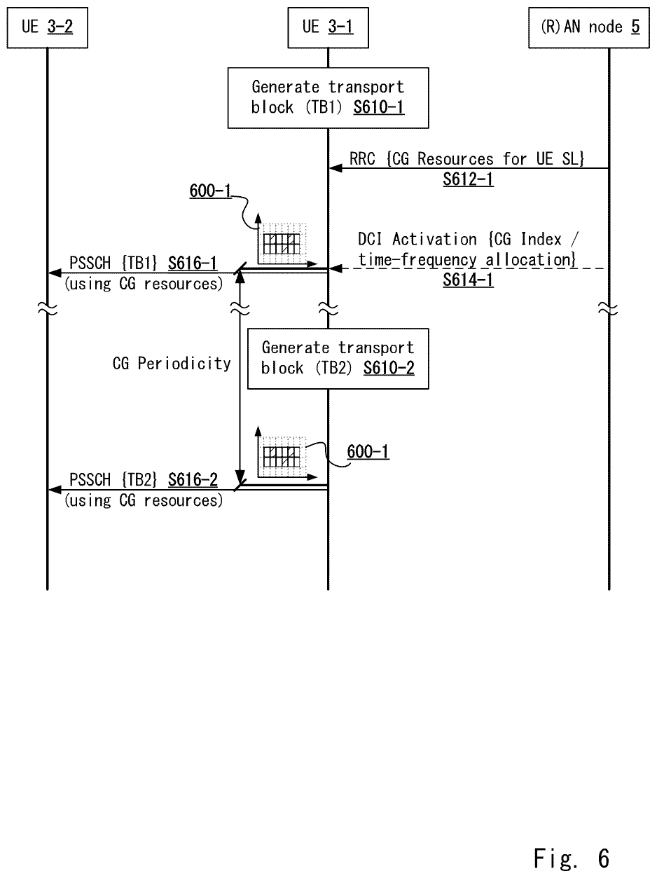

FIG. 6 is a simplified sequence diagram illustrating an exemplary configured grant procedure that may be implemented in the communication system 1.

As seen in FIG. 6, in the illustrated example, configured grant is used for transmitting two TBs (TB1 and TB2). When the UE 3-1, 3-2, 3-4 generates a transport block (TB1) at S610-1, the UE 3-1, 3-2, 3-4 does not request resources as it would for a dynamic grant, but waits until the base station 5 provides, at S612-1, a configured grant (CG) to the UE 3-1, 3-2, 3-4 to use for transmission of data (e.g., using radio resource control (RRC) signalling). The CG defines a set of resources 600-1 to be assigned periodically to the UE 3. The CG is configured using a set of parameters that includes the CG index, a time-frequency resource allocation and a periodicity of the allocated sidelink resources 600-1.

There are two possible two types of CG that may be used by the base station 5 and UE 3-1, 3-2, 3-4—CG type 1 and CG type 2. Both may be configured using RRC signalling (as illustrated at S612-1). For CG type 1 the resources 600-1 of the CG can be used immediately by the UE 3-1, 3-2, 3-4 until that CG is released by the base station 5 (also using RRC signalling). For CG type 2 the resources 600-1 of the CG can be used by the UE 3-1, 3-2, 3-4 only after the CG is activated, as indicated at S614-1, by the base station 5 (e.g. using DCI signalling). Once activated the type 2 CG remains active until deactivated (e.g. using DCI signalling). In this case the activation/deactivation DCI may also include the CG index and time-frequency allocation for CG type 2. Once the CG is received (and activated in the case of CG type 2), the UE 3-1, 3-2, 3-4 can then use the scheduled resources 600-1, at S616-1, to transmit TB1 (e.g., using the PSSCH).

When another transport block (TB2) is generated at S610-2, the UE 3-1, 3-2, 3-4 waits until the CG period is completed (i.e., when the resources 600-1 of the configured grant are effectively reassigned) before using the scheduled resources 600-1, at S616-2, to transmit TB2 (e.g., using the PSSCH). The time period configured for a CG may be adjusted to be equal to (or near equal to) the time expected between TBs based on information indicated by the UE 3-1, 3-2, 3-4 (for example, in UE assistance information).

The CG scheme reduces the time needed to transmit the two TBs compared to DG. However, the DG scheme has the potential for greater resource efficiency, especially when handling non-periodic traffic (since resources are only allocated when specifically needed for TB transmission).

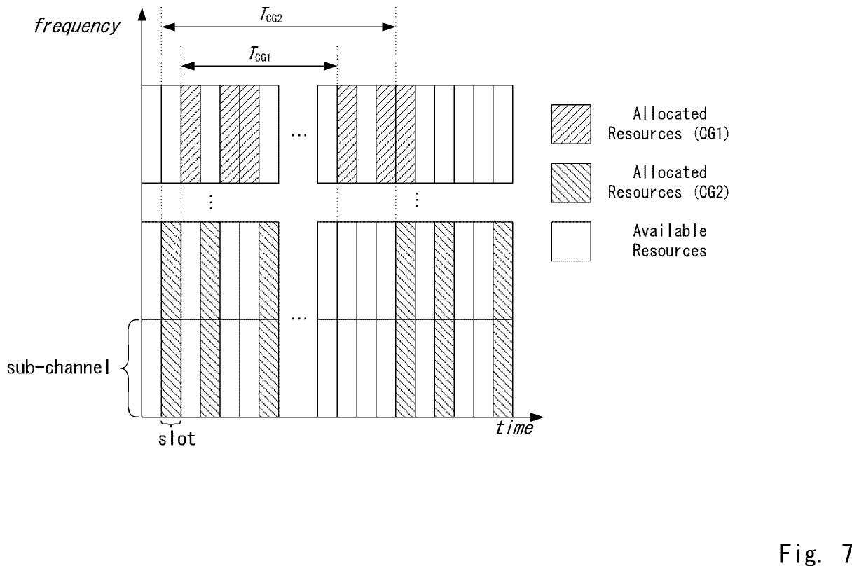

Referring to FIG. 7, which is an illustrative example of how different CGs may be configured in the communication system 1, CG type 2 can be used to configure a plurality of different CGs for a UE 3-1, 3-2, 3-4. For CG type 2, a subset of the configured CGs may be activated for a UE 3-1, 3-2, 3-4 based on the requirements of that UE 3-1, 3-2, 3-4 (while resources in other, non-active, CGs may be allocated to other UEs). CG type 1 can also be used to configure a plurality of CGs but, in this case, the UE has to activate the different CGs at the time of their configuration. Accordingly, while CG type 1 reduces the signalling and the time needed to initiate a transmission compared to CG type 2, if any of plural CG type 1 CGs are not used by a UE, those resources are not available for use by other UEs.

To support scheduling in the network managed resource allocation mode (mode 1), the UE 3-1, 3-2, 3-4, may provide the base station 5 with UE assistance information. The UE assistance information may indicate, for example, sidelink related information from which the base station 5 can infer expected sidelink traffic characteristics. The UE assistance information typically includes, for example: a periodicity for the TBs in the sidelink, a TB maximum size, and Quality of Service information. The QoS information may include, for example, KPIs such as the latency and reliability required by the TBs and their priority. The base station 5 can then use the UE assistance information to identify an appropriate CG that meets expected future sidelink traffic requirements.

The base station 5 can use the UE assistance information to identify a CG for uplink communication that best matches the characteristics and requirements of the traffic over the air interface. The UE assistance information may also be used to improve sidelink UE to network (e.g., vehicle to network) communications where communication in the sidelink, and communication over the air interface with the base station 5, share the same radio resources. The base station 5 may, for example, use UE assistance information about sidelink traffic characteristics for scheduling uplink transmissions to the base station 5 and to identify adequate CGs for uplink communication that minimise interference to sidelink communication. The UE assistance information reported to the base station 5 may include information for network managed mode (mode 1) or autonomous mode (mode 2) sidelink scheduling. The UE assistance information may include, for example, information about the sidelink traffic (e.g., a sidelink channel busy ratio for the sidelink resource pool), UE-related location/mobility information (e.g., position, speed). The base station 5 may, for example, use location information to determine in the network manage resource allocation mode, that the same resources can be assigned to different UEs because those UEs are sufficiently distanced from one another (or to avoid assignment of the same resources to UEs that are relatively close). In the case of autonomous mode, sidelink scheduling, location/mobility information could be used, for example, to allocate the same resource pool to sidelink UEs that are approaching one another.

### Autonomous Resource Allocation/Selection for Sidelink Communication

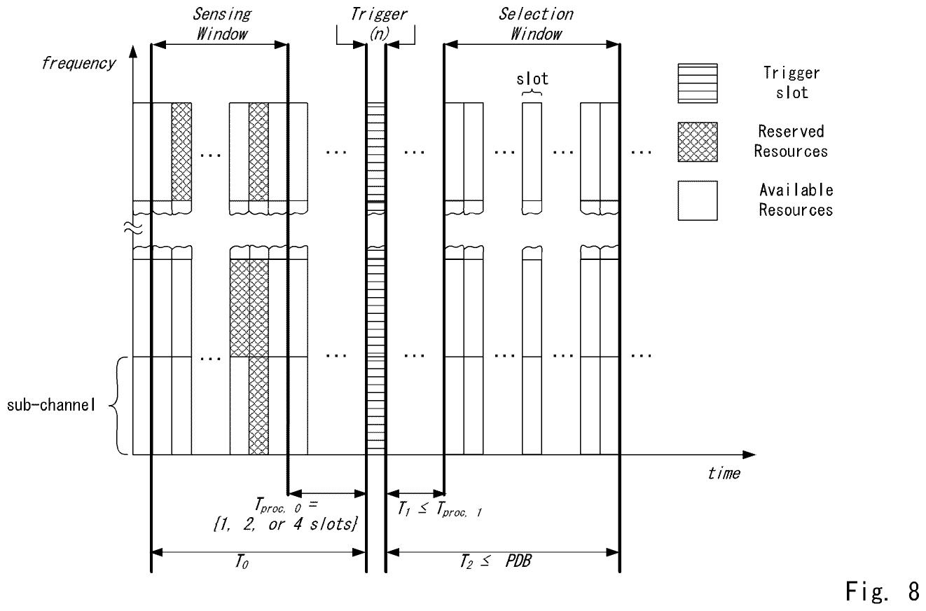

Each sidelink UE 3-1, 3-2, 3-4 is also configured for operation in an autonomous resource selection mode (e.g., mode 2 resource selection) in which the UE 3-1, 3-2, 3-4 can autonomously select sidelink resources (one or several sub-channels) from a resource pool (e.g., when the UE 3-1, 3-2, 3-4 is not in coverage of the base station 5). The autonomous allocation mode will now be described, by way of example only, with reference to FIG. 8, which is a simplified illustration of how autonomous mode resource selection may operate in the communication system of FIG. 1.

Specifically, when operating in the autonomous resource selection mode, a UE 3-1, 3-2, 3-4 can autonomously select sidelink resources (one or several sub-channels) from the resource pool (that may be preconfigured and/or configured by the base station when the UE 3-1, 3-2, 3-4 is in network coverage). NR autonomous mode (mode 2) resource allocation supports a dynamic scheduling scheme and a semi-persistent scheduling scheme. When using the dynamic scheme the UE 3-1, 3-2, 3-4 selects new resources for each TB and can only reserve resources (by notifying in-range UEs) for future retransmissions of that TB. The semi-persistent scheme can be enabled, or disabled, in a given resource pool by a (pre)configuration. When a UE 3-1, 3-2, 3-4 reserves a resource for future transmission it notifies nearby (‘neighbouring’) UEs using 1st stage SCI that is sent directly from one UE to another using a physical sidelink control channel (PSCCH). When using the semi-persistent scheduling scheme a UE 3-1, 3-2, 3-4 can select and reserve resources for the transmission of several TBs (and their retransmissions).

In the autonomous mode (mode 2) a UE selects new sidelink resources when it generates a new TB. Selection can also be triggered for the semi-persistent scheme when a new TB is too large to be sent in previously reserved resources.

In more detail, a higher (MAC) layer can request/trigger determination/selection of a subset of resources at layer 1 (L1/physical layer) from which the MAC layer can make a final selection of resources for a PSSCH/PSCCH transmission. To trigger this procedure in a given slot, the MAC layer may provide the following parameters to L1 for a PSSCH/PSCCH transmission:
a resource pool from which the resources are to be reported;
a layer 1 (L1) priority, prio_{TX};
the remaining packet delay budget (PDB);
the number of sub-channels to be used for the PSSCH/PSCCH transmission in a slot, L_{subCH}; and/or
(optionally) the resource reservation interval, P_{rsvp_TX}.
   To determine/select the subset of sidelink resources (either dynamic or semi-persistent), a UE 3-1, 3-2, 3-4 initially defines a time interval (corresponding to a range of slots), referred to as a selection window, including resources (referred to as candidate resources) from which new sidelink resources are selected for transmission of a TB.

When the UE is not transmitting, it performs a sensing operation to identify candidate resources that are available. The sensing operation is performed during a time interval, referred to as a sensing window, corresponding to range of slots. During the sensing process, the UE decodes 1st stage SCI received from other UEs 3-1, 3-2, 3-4 in the sensed sidelink resources. The respective 1st-stage SCI received from each UE 3-1, 3-2, 3-4 indicates the sidelink resources reserved for retransmissions of a TB associated with the 1st-stage SCI, and resources reserved for the initial transmission and retransmissions of the next TB. The UE 3-1, 3-2, 3-4 also measures the transmissions (e.g., reference signal received power (RSRP)) associated with respective 1st stage SCI received from other UEs 3-1, 3-2, 3-4. The UE 3-1, 3-2, 3-4 stores the sensed information (the decoded 1st stage SCI and the RSRP measurements) and determines, based on the sensed information, which candidate resources from the selection window should be excluded when a new selection is triggered (and hence those candidate resources that are available for selection).

When selecting resources from the selection window to be used for transmission, the UE may use a two-step procedure. In the first step the UE 3-1, 3-2, 3-4 restricts the candidate resources available for selection by excluding candidate resources from the selection window that have either been reserved or for which the UE 3-1, 3-2, 3-4 is unable to determine whether a reservation has been made. For example, the UE 3-1, 3-2, 3-4 excludes candidate resources in the selection window that it may not have received a corresponding reservation for (e.g., because the UE 3-1, 3-2, 3-4 was transmitting at the time the corresponding reservations would have been announced by another UE 3-1, 3-2, 3-4). The UE 3-1, 3-2, 3-4 also excludes candidate resources reserved by other UEs 3-1, 3-2, 3-4 in corresponding 1st stage SCIs detected and decoded during the sensing window, subject to a measured RSRP associated with the reservation exceeding a threshold, and a comparison of a traffic priority in the measured resources with a traffic priority for the UE 3-1, 3-2, 3-4. Specifically, the UE 3-1, 3-2, 3-4 excludes the resources where the measured RSRP is higher than a threshold and treats them as occupied if the traffic priority in the measured resources is higher than the UE's own traffic priority. The UE may, nevertheless, select occupied resources for which an associated traffic priority is lower than that of the UE 3-1, 3-2, 3-4. Hence, higher priority traffic may occupy resources even if they have been reserved by other UEs 3-1, 3-2, 3-4.

In the second step, after the exclusion of reserved resources from the selection window, the UE 3-1, 3-2, 3-4 performs a random selection of the sidelink resources from the list of available candidate resources (i.e., those remaining after the exclusion step). A UE 3-1, 3-2, 3-4 may, for example, select a specific percentage of the resources randomly from the best set of the remaining resources, e.g., 20% of the best resources with a measured RSRP less than a (pre-) configured threshold and based on the traffic priority. If the remaining resources after the exclusion procedure are less than the specific percentage (e.g., 20%) of all resources in the selection window, then the UE 3-1, 3-2, 3-4 may relax the RSRP threshold until it has identified at least the specific percentage (e.g., 20%—or 35% or 50% based on traffic priority) of all resources in the selection window for resource allocation. The identified set of ‘unoccupied’ resources is passed from the physical (PHY) layer to the MAC layer. The final selection of resources can thus be carried, in the MAC layer, on receipt the set of unoccupied resources from the physical layer. The selection of resources in the MAC layer can then be made based on a random selection procedure.

The start of the selection window, T₁, is defined by reference to the time resource (slot), n, at which new resource (re)selection is triggered (and selection of resources commences) and the processing time (in units of slots), T_{proc,1}, required by the UE 3-1, 3-2, 3-4 to identify candidate resources and select new sidelink resources for transmission. The end (and hence the size) of the selection window, T₂, (relative to the (re)selection trigger) is dependent on UE implementation but must be smaller than the packet delay budget (PDB) in units of slots.

The end of the sensing window is defined by reference to the time resource (slot), n, at which the next new resource (re)selection is triggered and the time (in units of slots), T_{proc,0}, required to complete the sensing procedure (typically equal to one slot for an SCS of 15 or 30 kHz, and equal to 2 or 4 slots for a SCS of 60 or 120 kHz, respectively). The start of the sensing window (and hence its size) is defined by reference to an integer, To, defined in number of slots (before the trigger n). To depends on the SCS configuration (e.g., having a value, in number of slots, that is equivalent to 1100 ms or 100 ms). The selected value may be determined based on the (pre)configuration of the resource pool.

### Support for Sidelink Communication Over Unlicensed Spectrum (SL-U)

The sidelink capable UEs 3-1, 3-2, 3-4 of the communication system 1 are also configured to provide support for sidelink communication over unlicensed spectrum (SL-U) based on a ‘listen-before-talk’ (LBT) channel access mechanism in which transmitting UEs 3-1, 3-2, 3-4 are typically expected to perform some form of clear channel assessment (CCA) involving “sensing” the medium to detect any transmissions from other nodes before acquiring, if the channel is clear/available, a channel occupancy time (COT) within which to transmitting. The CCA may, for example, involve energy detection (i.e., measuring the received RSRP of any signals transmitted from other devices) and determining whether a channel is idle or busy based on the detected energy.

Specifically, a transmitting UE 3-1, 3-2, 3-4 can access a channel on which one or more transmissions are to be performed, using an appropriate LBT channel access procedures, according to one of the Type 1 or Type 2 categories, to support operation over unlicensed spectrum. A Type 1 LBT channel access procedure would require the transmitting UE 3-1, 3-2, 3-4 to perform regular channel sensing. For a Type 2A channel access procedure, the transmitting UE 3-1, 3-2, 3-4 may transmit the transmission immediately after sensing the channel to be idle for a sensing interval of at least 25 μs. For a Type 2B channel access procedure, the transmitting UE 3-1, 3-2, 3-4 may transmit the transmission immediately after sensing the channel to be idle for a sensing interval of at least 16 μs. For a Type 2C channel access procedure, the UE 3-1, 3-2, 3-4 may transmit the transmission without sensing the channel before the transmission.

In the communication system 1, the existing sidelink autonomous mode (mode 2) resource allocation scheme is supported as the baseline for resource allocation for SL-U. In this context, in the communication system 1, the sensing-based resource selection is triggered before LBT is triggered (although it will be appreciated that in a variation on the communication system 1, sensing-based resource selection may be triggered after LBT is triggered).

Moreover, for SL-U a similar procedure is used to determine a CAPC for a sidelink data radio bearer (SL-DRB) or sidelink signalling radio bearer (SL-SRB) as is used for NR-U. Specifically a PC5 QoS identifier (PQI) may be used to determine the CAPC mapping as described for NR-U in the introduction. For an SL-DRB, a CAPC value is (pre)configurable per-DRB. For all SL-SRBs, the CAPC value is fixed to the highest priority (i.e., lowest CAPC value). Similarly, for all SL MAC CEs, a CAPC value is fixed to the highest priority (i.e., lowest CAPC value). For PQI-based CAPC mapping, at least the PDB (and possibly other parameters) can be used as a criterion to determine the CAPC. Moreover, for non-standardised PQI, the CAPC of the standardised PQI which best matches the QoS characteristics of the non-standardized PQI may be used. A UE 3-1, 3-2, 3-4 may determine the CAPC of a sidelink TB when the CAPC is not indicated in the DCI. If only one or more SL MAC CEs are included in the sidelink TB, the highest priority sidelink CAPC will be used. If sidelink control channel (SCCH) service data units (SDUs) are included in the sidelink TB, then the highest priority sidelink CAPC will be used.

### Support for Multiple Consecutive Slots Transmission (MCSt)

The sidelink capable UEs 3-1, 3-2, 3-4 of the communication system 1 are also configured to support sidelink communication involving multiple consecutive slots transmission (MCSt)).

As described in more detail later, to support MCSt, autonomous mode (mode 2) resource selection is used in which the MAC layer of the transmitting UE 3-1, 3-2, 3-4 provides a single set of parameters for triggering the physical layer (layer 1/L1) to report a subset of candidate multi-slot resources that can be selected for transmission. As for single-slot resources, these parameters may include, for example: a layer 1 (L1) priority, prio_{TX}; the remaining packet delay budget (PDB); the number of sub-channels to be used for the PSSCH/PSCCH transmission in a slot, L_{subCH}; and/or the resource reservation interval, P_{rsvp_TX}.

The multi-slot resources are then (randomly) selected from the set of candidate multi-slot resources, in the MAC layer, for the initial transmission and for re-transmissions of a single TB or multiple TBs.

In the communication system 1 of this example, L1 reports the set of candidate multi-slot resources as a candidate resource set, S_{A}, where each candidate multi-slot resource respectively consists of a set of single-slot resources that are consecutive in time (in this example, all having the same L_{subCH}, although this need not be the case).

Beneficially, when providing the set of parameters for triggering the physical layer to report the subset of candidate multi-slot resources, if the data (of a TB or multiple TBs) intended for transmission is from multiple sidelink logical channels (LCHs) and/or sidelink MAC CEs, the priority parameter (prio_{TX}) of the parameter set provided to L1 is based on the highest priority among the LCHs and/or MAC CEs (or is based on the lowest CAPC value associated with the LCHs, or MAC CEs). Moreover, beneficially, if the data (of a TB or multiple TBs) is from multiple sidelink logical channels and/or sidelink MAC CEs, the remaining PDB of the parameter set provided to L1 is based on the lowest remaining PDB among the LCHs and/or MAC CEs. It will be appreciated that determination of the priority parameter (prio_{TX}) based on the highest priority among the LCHs and/or MAC CEs, and determination of the remaining PDB parameter based on the lowest remaining PDB among the LCHs and/or MAC CEs, are not mutually dependent on one another and either parameter determination method may be implemented independently of one another.

Beneficially, when L1 provides the set of candidate multi-slot resources, if the data intended for transmission cannot be hosted by the indicated candidate multi-slot resources, the MAC layer may instruct the physical layer to perform a new resource selection for the (remaining) data (that is intended for transmission). This instruction may be before the actual transmission of the data or may be after the actual transmission of the data. On the other hand, if there is insufficient data in the buffer (e.g., RLC buffer) to be transmitted using the candidate multi-slot resources, the additional candidate multi-slot resources may be dropped. Alternatively (or additionally) the MAC layer may run a different SL logical channel prioritisation (LCP) procedure to allow the UE 3-1, 3-2, 3-4 to use (at least some of) the additional candidate multi-slot resources to transmit data to one or more different peer UEs 3-1, 3-2, 3-4. In this context it will be appreciated that, beneficially, unlike legacy SL LCP procedures, the transmitting UE 3-1, 3-2, 3-4 need not select a destination UE 3-1, 3-2, 3-4 with the highest priority for its data transmission among all destination UEs 3-1, 3-2, 3-4 for which data to be transmitted is pending—i.e., there is no such destination restriction.

### HARQ Operation for MCSt

The sidelink capable UEs 3-1, 3-2, 3-4 of the communication system 1 are also configured to support sidelink HARQ operation for MCSt (including in the context of SL-U).

Specifically, the sidelink capable UEs 3-1, 3-2, 3-4 of the communication system 1 are configured to support at least one of:
Transmission over the consecutive slots of the MCSt group being associated with a single sidelink HARQ process;
Transmission over the consecutive slots of the MCSt group being broken down into multiple sidelink HARQ processes;
HARQ initial transmission and/or retransmission within one MCSt group; and/or
Feedback based HARQ retransmission, and/or blind retransmission, within one MCSt group.

Beneficially, as discussed in more detail later, the MAC layer of a UE 3-1, 3-2, 3-4 may be configured to provide, to the physical layer, an indication of the intended transmission pattern to guide its resource selection. The information indicating the transmission pattern may include, for example, an indication of the number of one or more TBs for transmission, an indication of the HARQ transmission mechanism (e.g., feedback based/blind retransmission, the number of the sidelink HARQ processes used for the intended HARQ transmission, the number of blind retransmissions for the TB), a number of slots to be occupied for blind retransmission, and/or the like. Alternatively or additionally, the MAC layer can provide the whole size of the data to physical layer based on the calculation of the (re)transmission for TBs that is supposed for transmission over MCSt.

### LBT Failure Handling

As described in more detail later, the sidelink capable UEs 3-1, 3-2, 3-4 of the communication system 1 are also configured to implement one or more enhanced LBT failure handling mechanisms in the context of MCSt for SL-U.

Beneficially, in one LBT failure handling mechanism, rather than the physical layer reporting LBT failure, and thereby triggering resource (re)selection as soon as LBT failure first occurs (e.g., in the first slot of an MCSt slot group) the physical layer does not provide an LBT failure indication to the MAC layer unless (and until) the UE 3-1, 3-2, 3-4 has experienced LBT failure for all of slots within that MCSt slot group.

Alternatively, in another LBT failure handling mechanism, the physical layer beneficially provides a respective LBT failure indication to the MAC layer for each LBT failure sequentially until LBT is successful (i.e., providing plural LBT failure indications if more than one LBT failure is experienced in consecutive slots). Rather than simply trigger resource (re)selection, however, on receipt of an LBT failure indication the MAC layer may adjust the planned transmission/retransmission of one or more TBs to take account of one or more slots of the MCSt slot group within which LBT failure occurred.

In another LBT failure handling mechanism, the physical layer beneficially provides a single LBT failure indication to the MAC layer if there are any LBT failures within one or more of the slots of the MCSt slot group. The physical layer also provides an indication of one or more slots within which the UE experienced LBT failure. As with the previous example, rather than simply trigger resource (re)selection, however, on receipt of the LBT failure indication the MAC layer may adjust the planned transmission/retransmission of one or more TBs to take account of one or more slots of the MCSt slot group within which LBT failure occurred.

### Logical Channel Prioritisation (LCP) and CAPC

As indicated above, there is a risk that an MCSt transmission may block lower CAPC level (i.e., higher priority) data. To help mitigate this risk, the sidelink capable UEs 3-1, 3-2, 3-4 of the communication system 1 are also configured to implement one or more enhanced mechanisms for LCP, in the context of MCSt, based on the CAPC associated with the data provided via the corresponding LCH.

In one LCP mechanism, data with different CAPC levels is multiplexed (in the MAC layer of the UE) into one or more TBs for transmission using the MCSt slot group. In this example, pre-emption is not allowed during an MCSt based transmission even in the event that lower CAPC level (higher priority) data arrives during the MCSt slot group.

Beneficially, in another LCP mechanism, data with same CAPC level is multiplexed (in the MAC layer of the UE) into one TB among the TBs for transmission using the MCSt slot group. In this example, pre-emption is allowed during MCSt based transmission, for example when lower CAPC level (higher priority) data arrives during the MCSt slot group. During pre-emption, the transmission of a pre-empted TB higher CAPC level (lower priority) may be postponed. For example, the MAC layer may request the physical layer to perform resource selection (MCSt or single slot resource) for such transmission.

Beneficially, in another LCP mechanism, during LCP at the MAC layer, only data having a specific range of (lower) CAPC levels are allowed to be multiplexed into one or more TBs for transmission using the MCSt slot group. In this example, therefore, only some high priority data (corresponding to the specific range of (lower) CAPC levels) is allowed to be transmitted in the MCSt slot group. With this mechanism, pre-emption is only allowed during MCSt based transmission, if newly arriving data has a higher priority than all the data multiplexed within one or more TBs to be transmitted over the MCSt slot group. For example, if the data multiplexed within one or more TBs to be transmitted have a range of CAPC levels from CAPC 2 and CAPC 3, only newly arriving data with CAPC 1 can pre-empt its transmission.

### User Equipment

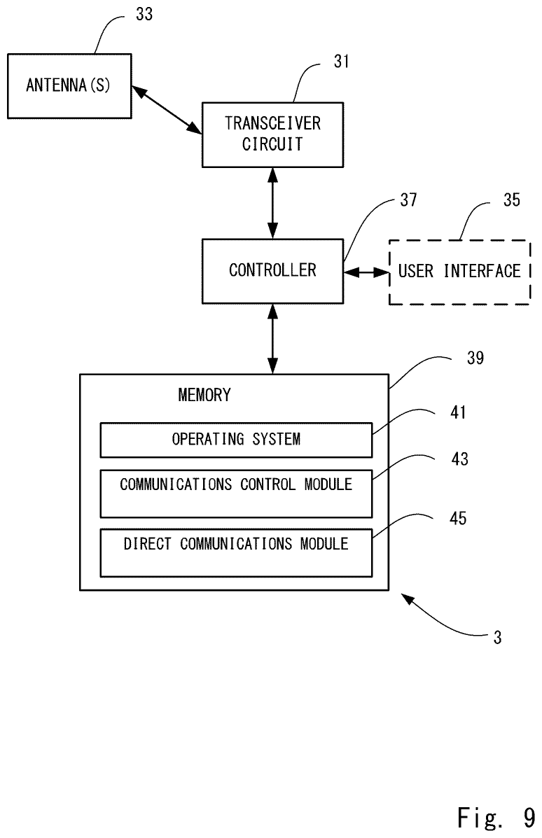

FIG. 9 is a schematic block diagram illustrating the main components of a UE 3 for the communication system 1 shown in FIG. 1. In this example the UE 3 is a UE that is capable of performing sidelink communication.

As shown, the UE 3 has a transceiver circuit 31 that is operable to transmit signals to and to receive signals from a base station 5 via one or more antenna 33. The UE 3 includes a subscriber identity module (SIM) which may be implemented in any suitable manner, for example physically (e.g., as a universal integrated circuit card (UICC) or the like) or virtually (e.g., as an embedded SIM (eSIM) or the like). The UE 3 also has a controller 37 to control the operation of the UE 3. The controller 37 is associated with a memory 39 and is coupled to the transceiver circuit 31.

Although not necessarily required for its operation, the UE 3 might, of course, have all the usual functionality of a conventional UE 3 (e.g., a user interface 35, such as a touch screen/keypad/microphone/speaker and/or the like for, allowing direct control by and interaction with a user) and this may be provided by any one or any combination of hardware, software, and firmware, as appropriate. Software may be pre-installed in the memory 39 and/or may be downloaded via the communication network or from a removable data storage device (RMD), for example.

In addition to subscriber information and security information (such as the UE's international mobile subscriber identity (IMSI) and encryption keys), the SIM can store UE pre-configuration information for preconfiguring the UE 3.

The controller 37 is configured to control overall operation of the UE 3 by, in this example, program instructions or software instructions stored within memory 39. As shown, these software instructions include, among other things, an operating system 41, a communications control module 43 and a direct communications module 45.

The communications control module 43 is operable to control the overall communication between the UE 3 and its one or more serving base stations 5 (and other communication devices connected to the base station 5, such as further UEs and/or core network nodes). The communications control module 43 handles, for example, the generation/sending/receiving of signalling messages and sidelink/uplink/downlink data packets between the UE 3 and other nodes and devices. The signalling may comprise control signalling (e.g., via system information or RRC) related to UE positioning. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an IP sub-module, an RRC sub-module, etc. The communications control module 43 is also responsible for the overall handling uplink communications via associated uplink channels (e.g., via a physical uplink control channel (PUCCH) and/or a physical uplink shared channel (PUSCH)) including both dynamic and semi-static signalling (e.g., SRS). The communications control module 43 is also configured for the overall handling of receipt of downlink communications via associated downlink channels (e.g., via a physical downlink control channel (PDCCH) and/or a physical downlink shared channel (PDSCH)) including both dynamic and semi-static signalling. The communications control module 43 is responsible for determining the resources to be used by the UE 3, to determine how frequency resources and/or slots/symbols are configured (e.g., for UL communication, DL communication, or the like), and to determine which one or more bandwidth parts are configured for the UE 3.

The direct communications module 45 operates under the overall control of the communications control module 43 and is responsible for direct UE-to-UE (i.e., sidelink) communication. The direct UE-to-UE communication may be based, for example, on control information/configuration information received (e.g., via the communications control module 43) from the base station 5 (e.g., in downlink control information (DCI) provided in the PDCCH, RRC or MAC signalling), or from other UEs 3 (e.g., in sidelink control information (SCI) provided in the PSCCH or PSSCH, or in RRC signalling sent/transferred via the PC5 interface (e.g., using PC5-RRC signalling)). It will nevertheless be appreciated that the direct UE-to-UE communication may be based fully or partially on configuration information obtained from the SIM (e.g., stored as UE pre-configuration information). The direct communications module 45 is also responsible for determining, based on the control information/configuration information, the resource pools (shared and/or dedicated) and associated resources within those pools to be used by the UE 3 for direct UE-to-UE communication.

### Base Station

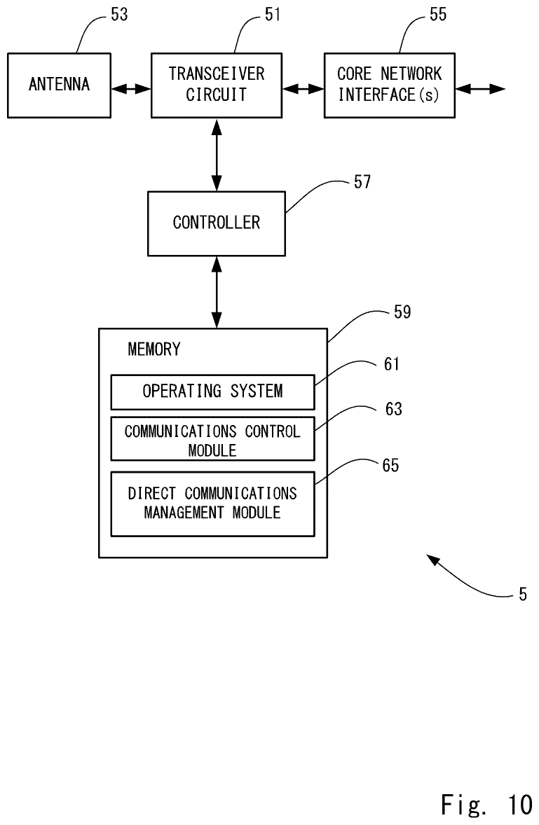

FIG. 10 is a schematic block diagram illustrating the main components of the base station 5 for the communication system 1 shown in FIG. 1. As shown, the base station 5 has a transceiver circuit 51 for transmitting signals to and for receiving signals from the communication devices (such as UEs 3) via one or more antenna 53 (e.g., an antenna array/massive antenna), and a core network interface 55 (e.g., comprising the N2, N3 and other reference points/interfaces) for transmitting signals to and for receiving signals from network nodes in the core network 7. Although not shown, the base station 5 may also be coupled to other base stations via an appropriate interface (e.g., the so-called ‘Xn’ interface in NR). The base station 5 has a controller 57 to control the operation of the base station 5. The controller 57 is associated with a memory 59. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within memory 59.

As shown, these software instructions include, among other things, an operating system 61, a communications control module 63, a direct communications management module 65, and a positioning module 67.

The communications control module 63 is operable to control the communication between the base station 5 and UEs 3 and other network entities that are connected to the base station 5. The communications control module 63 is configured for the overall control of the reception of uplink communications, via associated uplink channels (e.g., via a physical uplink control channel (PUCCH) and/or a physical uplink shared channel (PUSCH)) including both dynamic and semi-static signalling. The communications control module 63 is also configured for the overall handling of the transmission of downlink communications via associated downlink channels (e.g., via a physical downlink control channel (PDCCH) and/or a physical downlink shared channel (PDSCH)) including both dynamic and semi-static signalling.

The direct communications management module 65 is responsible for managing network-controlled aspects of direct UE-to-UE (i.e., sidelink) communication (e.g., for an in-coverage UE or an out-of-coverage UE that is communicating with an in-coverage UE in a partial coverage sidelink scenario). The direct communications module 65 is responsible, for example, for managing the transmission control information/configuration information for direct UE-to-UE communication to a UE 3 (e.g., in downlink control information (DCI) provided in the PDCCH, RRC or MAC signalling) possibly for relaying by a recipient UE to an out-of-coverage UE (e.g., via the PC5 interface (e.g., PC5-RRC signalling)). The control information/configuration information may include, for example, information for configuring the resource pools (shared and/or dedicated) and/or for allocating associated resources within those pools to be used by the UE 3 for direct UE-to-UE communication.

### MCSt Resource Selection

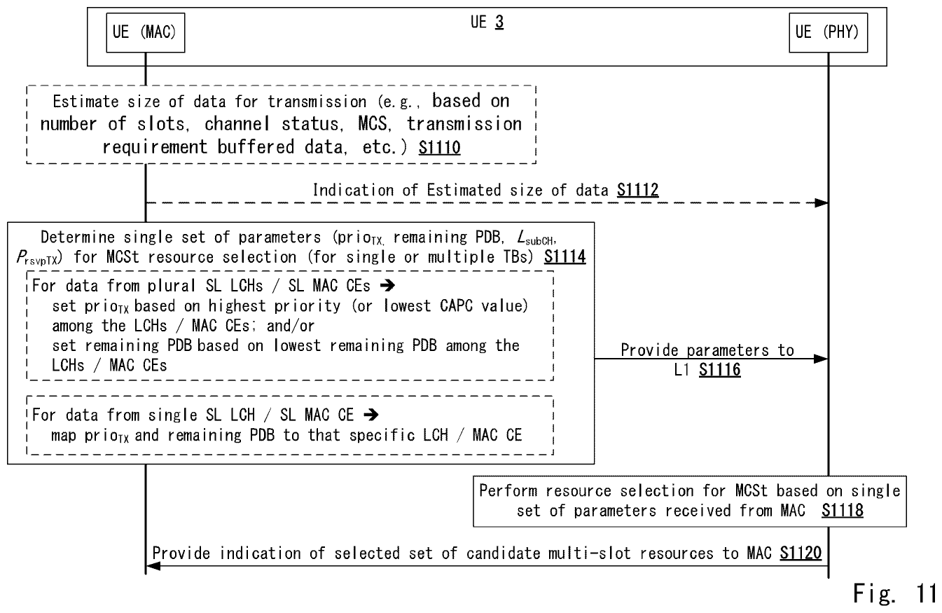

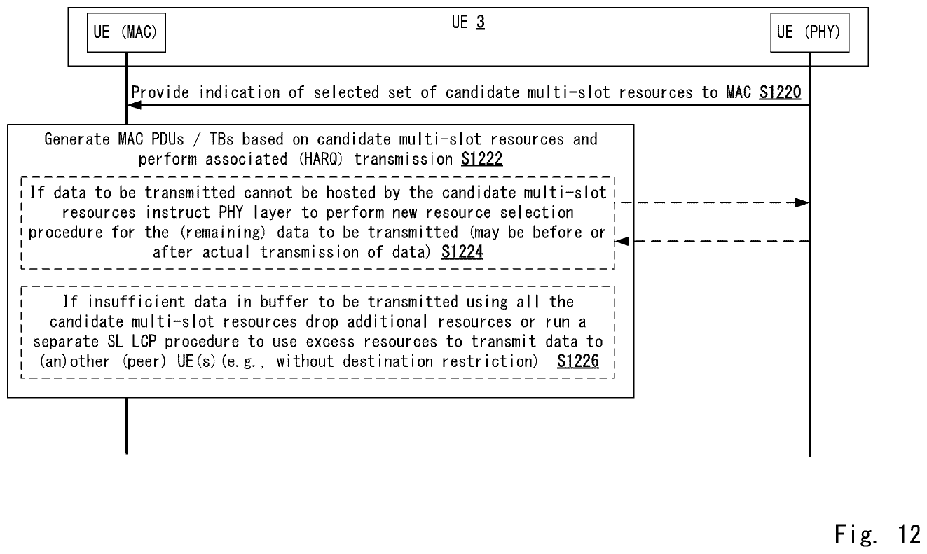

The way in which a UE's MAC and physical layers may coordinate during MCSt resource selection for sidelink communication will now be discussed in more detail, by way of example only, with reference to FIGS. 11 and 12.

FIG. 11 is a simplified sequence diagram illustrating a procedure for autonomous MCSt resource selection for the communication system 1.

As seen in FIG. 11 at S1110, the MAC layer may predict a size of the data for transmission. The size may be provided as an estimated size that is predicted based on information related to data in the buffer (e.g., a number of slots required for transmission, a channel status, a modulation and coding scheme (MCS), a transmission requirement for the data, and/or the like). The MAC layer may then provide at S1112, an indication of the predicted size to the physical layer before the MAC layer provides any parameters (e.g., prio_{TX}, remaining PDB, L_{subCH} and/or P_{rsvp_TX}), for MCSt resource selection.

The MAC layer may then determine, at S1114, a single set of parameters (prio_{TX}, remaining PDB, L_{subCH} and P_{rsvp_TX}) for MCSt resource selection at the physical layer and provide that set of parameters to the physical layer at S1116.

When providing the set of parameters for triggering the physical layer to report the subset of candidate multi-slot resources, if the data (of a TB or multiple TBs) intended for transmission is from multiple sidelink logical channels (LCHs) and/or sidelink MAC CEs, then the priority parameter (prio_{TX}) of the parameter set provided to the physical layer is based on the highest priority among the LCHs and/or MAC CEs (or is based on the lowest CAPC value associated with the LCHs, or MAC CEs). Moreover, if the data (of a TB or multiple TBs) is from multiple sidelink logical channels and/or sidelink MAC CEs, then the remaining PDB of the parameter set provided to the physical layer is based on the lowest remaining PDB among the LCHs and/or MAC CEs. It will, nevertheless, be appreciated that determination of the priority parameter (prio_{TX}) based on the highest priority among the LCHs and/or MAC CEs, and determination of the remaining PDB parameter based on the lowest remaining PDB among the LCHs and/or MAC CEs, are not mutually dependent on one another and either parameter determination method may be implemented independently of one another.

If, on the other hand, the data (of the TB or multiple TBs) is from a single sidelink logical channel and/or sidelink MAC CE, then the parameter (prio_{TX}) of the parameter and remaining PDB of the parameter set provided to the physical layer is mapped to that particular SL logical channel or MAC CE.

On receipt of the single set of parameters at S1116, the physical layer of the UE may then perform autonomous resource selection, at S1118, based on the single set of parameters (e.g., in a similar manner to that described above with reference to FIG. 8). The physical layer then reports the selected set of candidate multi-slot resources to the MAC layer of the UE 3 at S1120.

In the communication system 1 of this example, the physical layer reports the set of candidate multi-slot resources as a candidate resource set, SA, where each candidate multi-slot resource respectively consists of a set of single-slot resources that are consecutive in time.

The multi-slot resources can then be (randomly) selected from the set of candidate multi-slot resources, in the MAC layer, for the initial transmission and for re-transmissions of a single TB or multiple TBs.

FIG. 12 is a simplified sequence diagram illustrating a procedure that may be performed following autonomous selection of a candidate set of MCSt resources in the communication system 1.

As seen in FIG. 12, the physical layer reports a selected (or reselected) set of candidate multi-slot resources to the MAC layer of the UE 3 at S1220. These resource may, for example, be selected using a procedure similar to that described with reference to FIG. 11 or a different procedure.

The MAC later then generates, at S1222, one or more MAC protocol data units (PDUs) to be transmitted as one or more TBs based in the candidate multi-slot resources and then performs an associated (HARQ) transmission.

When the physical layer has provided the set of candidate multi-slot resources, if the indicated candidate multi-slot resources are insufficient for full transmission of the data for transmission, then the MAC layer instructs (at S1224) the physical layer to perform a new resource selection for the (remaining) data (that is intended for transmission). This may be before the actual transmission of the data at S1222 or may be after the actual transmission of the data.

On the other hand, as seen at S1226, if there is insufficient data in the buffer (e.g., RLC buffer) to be transmitted using the candidate multi-slot resources, the additional candidate multi-slot resources may be dropped. Alternatively (or additionally) the MAC layer may run a different SL logical channel prioritisation (LCP) procedure to allow the UE to use (at least some of) the additional candidate multi-slot resources to transmit data to one or more different peer UEs. In this context it will be appreciated that, beneficially, unlike legacy SL LCP procedures, the transmitting UE need not select a destination UE with the highest priority for its data transmission among all destination UEs for which data to be transmitted is pending—i.e., there is no such destination restriction.

### HARQ Operation for MCSt

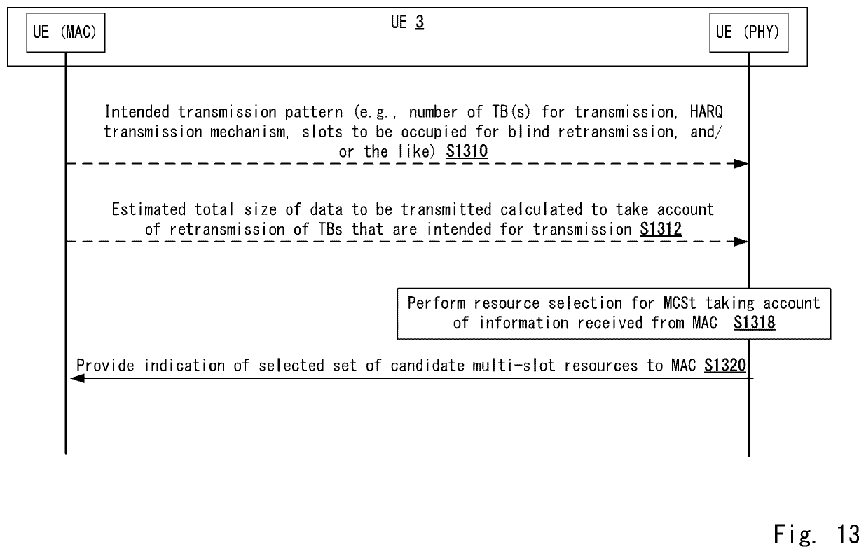

The way in which a UE's MAC and physical layers may coordinate during MCSt resource selection for sidelink communication to support sidelink HARQ operation for MCSt (including in the context of SL-U) will now be discussed in more detail, by way of example only, with reference to FIGS. 13 to 18.

FIG. 13 is a simplified sequence diagram illustrating a procedure for supporting autonomous MCSt resource selection, in the context of HARQ operation, that may be performed in the communication system 1.

As seen at S1310 the MAC layer of the UE 3-1, 3-2, 3-4 may provide, to the physical layer, an indication of the intended transmission pattern. The information indicating the transmission pattern may include, for example, an indication of the number of one or more TBs for transmission, an indication of the HARQ transmission mechanism (e.g., feedback based/blind retransmission, the number of the sidelink HARQ processes used for the intended HARQ transmission, the number of blind retransmissions for the TB), slots to be occupied for blind retransmission, and/or the like.

As seen at S1312, alternatively or additionally, the MAC layer of the UE 3-1, 3-2, 3-4 may provide, to the physical layer, an indication of an estimated total size of data to be transmitted that has been calculated to take account of retransmission of TBs that are intended for transmission over the slots of the MCSt.

On receipt of the information from the MAC layer, the physical layer of the UE may then perform autonomous resource selection, at S1318, based on the information. The physical layer then reports the selected set of candidate multi-slot resources to the MAC layer of the UE 3 at S1320.

It will be appreciated that whilst the respective information elements provided at S1310 and S1312 is shown as being provided separately for simplicity, the respective information may be provided together (where both information elements are provided). It will also be appreciated that one or more information elements may be provided as part of a procedure similar to that described with reference to FIG. 11.

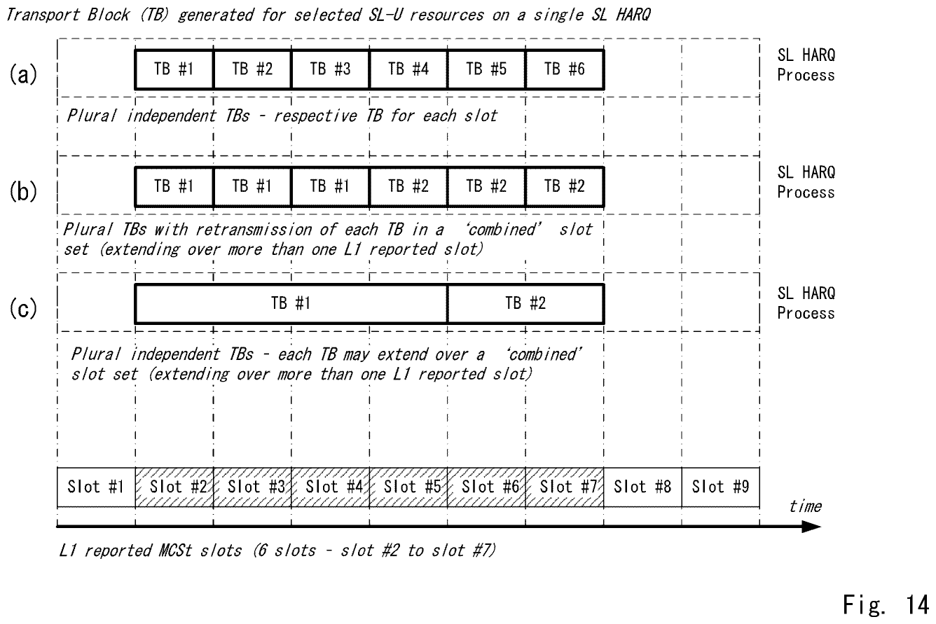

FIG. 14 to FIG. 18 illustrate a number of different ways in which HARQ process based transmission may take place in the communication system 1 for a given set of MCSt slots.

Referring to FIG. 14, which is a simplified diagram illustrating a number of different ways in which HARQ process based transmission, with HARQ feedback disabled, may take place in the communication system 1.

As seen in FIG. 14, in each of the illustrated examples, TB (re)transmissions take place in selected SL-U resources of an MCSt slot group comprising six consecutive slots (slot #2 to slot #7) and use only a single HARQ process. It will be appreciated that this is purely illustrative, and any suitable number of consecutive slots may be reported by the physical layer.

In example (a) illustrated in FIG. 14, a plurality of different TBs (in this example six TBs) are transmitted independently in the slots selected for MCSt with a different respective TB (TB #1 to TB #6) being transmitted in each slot. This maximises the number of separate TBs that can be sent for a given MCSt slot group.

In example (b) illustrated in FIG. 14, like example (a), a plurality of different TBs are transmitted independently in the slots selected for MCSt. In this example, however, an initial transmission and subsequent blind retransmissions of each TB are performed in a combined slot set comprising a subset of consecutive time resources from within the MCSt slot group. By way of illustration, in the illustrated example, TB #1 is transmitted, and then blindly retransmitted, in a combination of three consecutive slots (slots #2 to #4) of the MCSt slot group. TB #2 is then transmitted, and then blindly retransmitted, in a combination of the three consecutive slots (slots #5 to #7) of the MCSt slot group set subsequent to those used for the earlier (re)transmissions.

It can be seen that example (b) corresponds to transmission and blind retransmissions for one or more TBs, where each (re)transmission of the TB has a different associated redundancy version (RV). The MAC layer may indicate, to the physical layer, the RV and slots to be used for the planned initial transmission and blind retransmissions within the SL HARQ process. Specifically, based on the configuration of the blind retransmission numbers, after generation of a MAC PDU, the MAC layer may provide an indication of the slots selected by the MAC layer within the MCSt slot group, to the physical layer to instruct transmission.

In example (c) illustrated in FIG. 14, like example (a), a plurality of different TBs are transmitted independently in the slots selected for MCSt. However, in this example the size of each TB is not restricted to a size that is transmittable within a single slot. Instead a relatively large TB (e.g., of a size that is too large to be transmitted in a single slot) may be transmitted using a combined slot set comprising a subset of consecutive slots from within the slots selected for MCSt. By way of illustration, in the illustrated example, TB #1 is a very large TB (requiring the resources of four slots for full transmission) that is transmitted in a combination of four consecutive slots (slots #2 to #5) of the MCSt slot group. TB #2, on the other hand, is smaller than TB #1 but is nevertheless still relatively large, requiring the resources of two slots consecutive slots (slots #6 to #7) for full transmission. Whilst this example has the advantage of allowing transmission of very large TBs it introduces complexities in the context of retransmission (e.g., blind retransmissions).

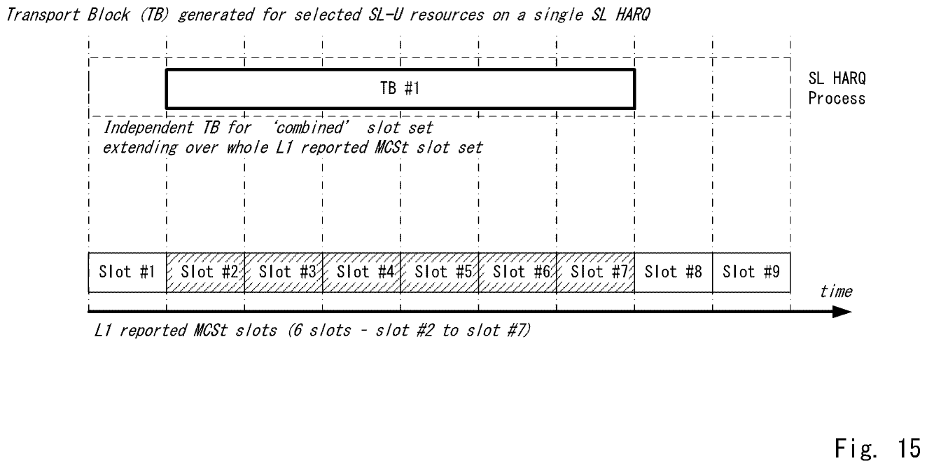

FIG. 15 is a simplified diagram illustrating another way in which HARQ process based transmission may take place in the communication system 1.

As seen in FIG. 15, a single TB transmission takes place in selected SL-U resources of an MCSt slot group comprising six consecutive slots (slot #2 to slot #7) and uses only a single HARQ process. It will be appreciated that this is purely illustrative, and any suitable number of consecutive slots may be reported by the physical layer.

Specifically, in the illustrated example, a single (very large) TB (TB #1) is transmitted over a combined slot set comprising, in the example, all of the slots of the MCSt slot group (although a smaller TB may be transmitted over only part of the MCSt slot group—i.e., a combined subset of consecutive slots from within the MCSt slot group). In this example, HARQ feedback may either be disabled or enabled.

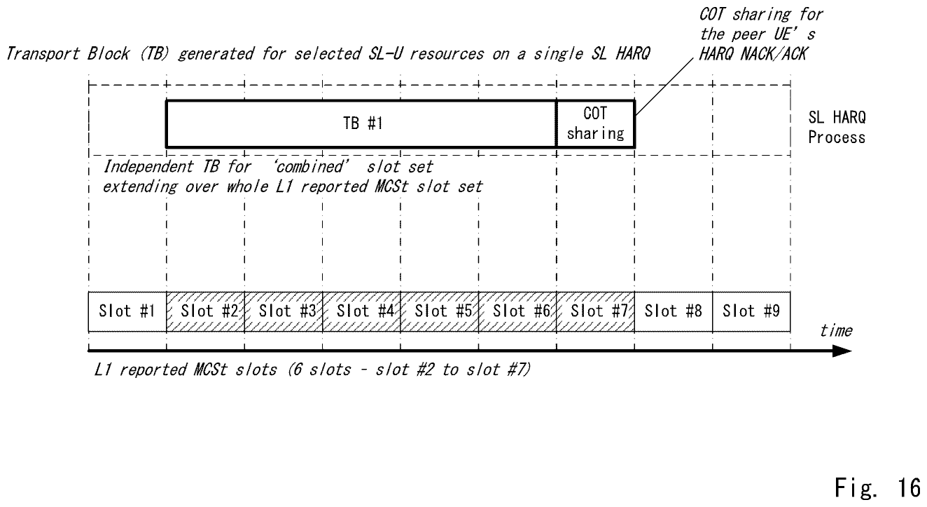

FIG. 16 is a simplified diagram illustrating another way in which HARQ process based transmission may take place in the communication system 1.

As seen in FIG. 16, a single TB transmission takes place in selected SL-U resources of an MCSt slot group comprising six consecutive slots (slot #2 to slot #7) and uses only a single HARQ process. It will be appreciated that this is purely illustrative, and any suitable number of consecutive slots may be reported by the physical layer.

Specifically, in the illustrated example, a single (very large) TB (TB #1) is transmitted by a transmitting UE to a peer UE over a combined slot set comprising, in the example, a subset of five of the slots of the MCSt slot group.

In this example, HARQ feedback is enabled and the last slot of the MCSt slot group is used for the peer UE's HARQ feedback. In the context of SL-U, this represents part of a channel occupancy time (COT) acquired by the transmitting UE for transmission of the TB that is shared with the peer UE to allow HARQ feedback (and/or other transmissions) to be sent by the peer UE without requiring performance of LBT by the peer UE.

It can be seen that this example supports transmission of a single TB over part of the MCSt slot group. During the transmission, the transmitting UE will transmit appropriate COT sharing information (e.g., identifying the shared slots) for the peer UE's HARQ feedback (HARQ NACK/ACK) and/or for one or more other transmissions from the peer UE to the transmitting UE.

The peer UE can thus provide appropriate feedback (HARQ NACK/ACK) over the indicated slots to the transmitting UE. Alternatively (or additionally), the peer UE may perform data transmission, using the shared COT resources, to the transmitting UE.

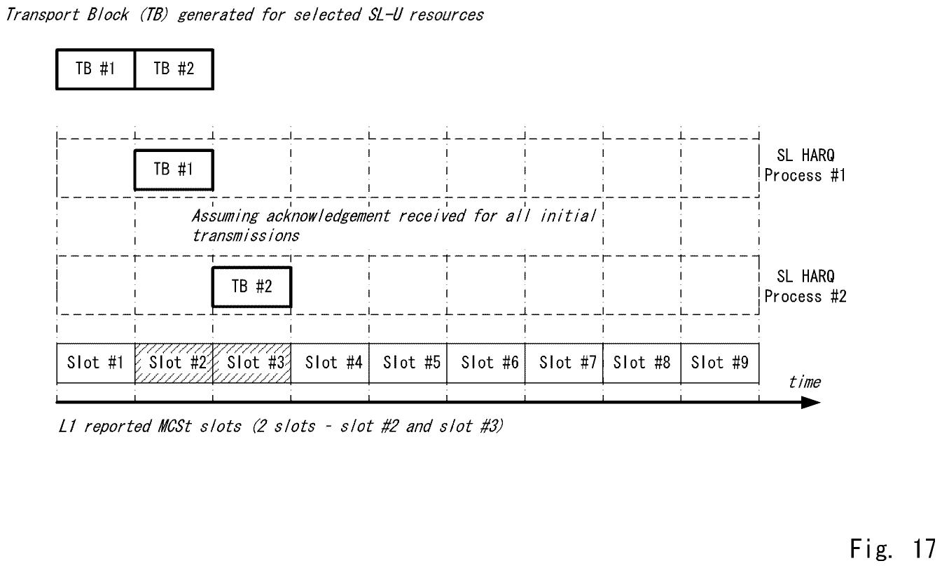

FIG. 17 is a simplified diagram illustrating another way in which HARQ process based transmission may take place in the communication system 1.

As seen in FIG. 17, plural TBs are transmitted, in an interleaved manner, in selected SL-U resources of an MCSt slot group comprising two consecutive slots (slot #2 and slot #3) using a different respective HARQ process for each TB. It will be appreciated that this is purely illustrative, and any suitable number of consecutive slots may be reported by the physical layer.

Specifically, in the illustrated example, one TB (TB #1) is transmitted using a first slot (slot #2) of the MCSt slot group as part of a first HARQ process and another TB (TB #2) is transmitted using a second slot (slot #3) of the MCSt slot group as part of a second HARQ process.

In more detail, in this example, the MAC layer may trigger the physical layer to perform resource selection for MCSt with a single set of parameters, and the physical layer reports all of the candidate consecutive slots to MAC layer (e.g., as described previously). The MAC layer may then generate a plurality of TBs, for example based on the data in a (RLC) buffer (e.g., having same priority (ProSe Per-Packet Priority (PPPP)) for the same destination UE. The MAC layer may generate the plurality of TBs to use multiple HARQ processes to transmit the TBs in an interleaved manner during feedback based HARQ retransmission as illustrated. It will be appreciated that, in the illustrated example, it is assumed that acknowledgements are received for all initial transmissions (meaning that no retransmissions are required).

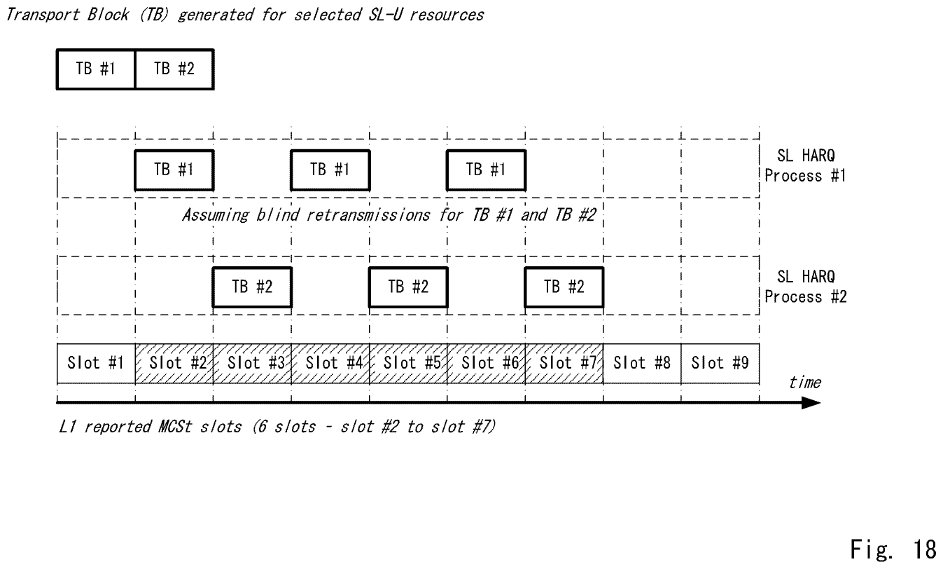

FIG. 18 is a simplified diagram illustrating another way in which HARQ process based transmission may take place in the communication system 1.

As seen in FIG. 18, plural TBs are transmitted and blindly retransmitted in selected SL-U resources of an MCSt slot group comprising six consecutive slots (slot #2 to slot #7) using a different respective HARQ process for each TB. It will be appreciated that this is purely illustrative, and any suitable number of consecutive slots may be reported by the physical layer.

Specifically, in the illustrated example, one TB (TB #1) is initially transmitted using a first slot (slot #2) of the MCSt slot group as part of a first HARQ process and another TB (TB #2) is transmitted using a second slot (slot #3) of the MCSt candidate resource set as part of a second HARQ process. Blind retransmissions of the first TB (TB #1) are then performed in later slots (slot #4 and slot #6) of the MCSt slot group in an interleaved manner with blind retransmissions of the second TB (TB #2) that are performed in other later slots (slot #5 and slot #7) of the MCSt slot group.

It will, nevertheless, be appreciated that whilst the initial transmission and retransmissions of the first TB are, in the illustrated example, interleaved with the initial transmission and retransmissions of the second TB this need not be the case. For example, the initial transmission and retransmissions of the first TB may be performed in one subset of consecutive slots (e.g., slots #2 to #4) and the initial transmission and retransmissions of the second TB may be performed in a later subset of consecutive slots (e.g., slots #5 to #7)—e.g., to mimic TB repetition.

It can be seen, therefore, that in this example the MAC layer may generate plural different TBs to use different HARQ processes to transmit the TBs in an interleaved (or consecutive) manner during HARQ blind retransmission.

### LBT Failure Handling

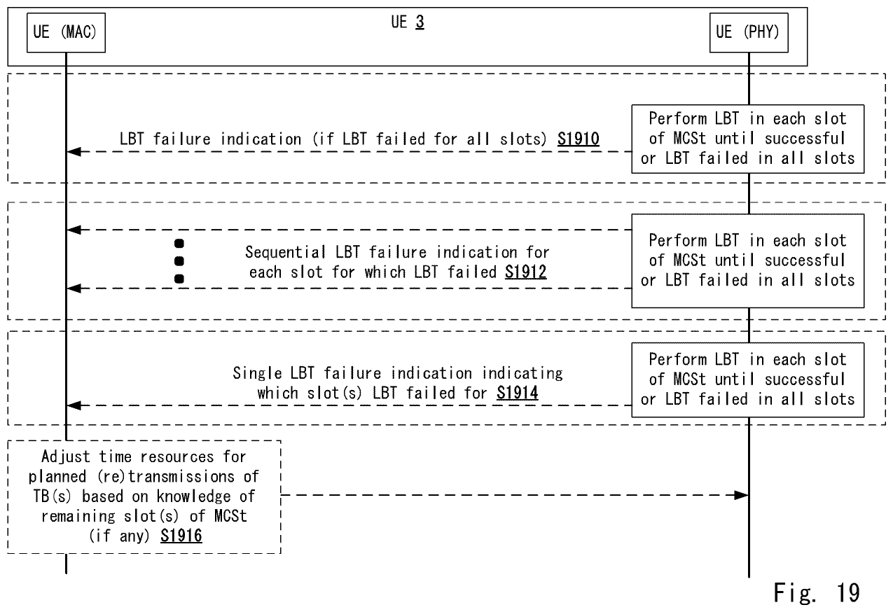

The way in which LBT failure handling may be implemented in the communication system 1 for MCSt will now be discussed in more detail, by way of example only, with reference to FIGS. 19 to 21.

FIG. 19 is a simplified sequence diagram illustrating a number of different LBT failure handling mechanisms that may be used in the communication system 1.

As seen in FIG. 19, in one LBT failure handling mechanism, LBT is performed in each slot of the MCSt slot group until successful, or until LBT has failed in every slot of the MCSt slot group. If LBT fails in all slots of the MCSt slot group, then the physical layer provides an LBT failure indication to the MAC layer unless as seen at S1910.

As seen in FIG. 19, in another LBT failure handling mechanism, LBT is performed in each slot of the MCSt slot group until successful, or until LBT has failed in every slot of the MCSt slot group. In this mechanism, however, the physical layer beneficially provides a respective LBT failure indication to the MAC layer for each LBT failure sequentially until LBT is successful (i.e., providing plural LBT failure indications if more than one LBT failure is experienced in consecutive slots) or until LBT has failed in every slot of the MCSt slot group. On receipt of an LBT failure indication the MAC layer may then adjust the planned transmission/retransmission of one or more TBs to take account of one or more slots of the MCSt slot group within which LBT failure occurred at S1916 based on knowledge of one or more remaining slots of MCSt slot group. For example, an initial transmission for a TB may be delayed until a later slot/consecutive slots within the MCSt slot group (for which LBT is successful). Similarly, a planned number of blind retransmissions may be reduced due to an LBT failure for one or more slots within a MCSt slot group.

As seen in FIG. 19, in another LBT failure handling mechanism, LBT is performed in each slot of the MCSt slot group until successful, or until LBT has failed in every slot of the MCSt slot group. In this mechanism, however, the physical layer beneficially provides a single LBT failure indication to the MAC layer if there are any LBT failures within one or more of the slots of the MCSt slot group. The physical layer also provides an indication of one or more slots within which the UE experienced LBT failure. As with the previous example, on receipt of an LBT failure indication the MAC layer may then adjust the planned transmission/retransmission of one or more TBs to take account of one or more slots of the MCSt slot group within which LBT failure occurred at S1916 based on knowledge of one or more remaining slots of MCSt slot group. For example, an initial transmission for a TB may be delayed until a later slot/consecutive slots within the MCSt slot group (for which LBT is successful). Similarly, a planned number of blind retransmissions may be reduced due to an LBT failure for one or more slots within a MCSt slot group.

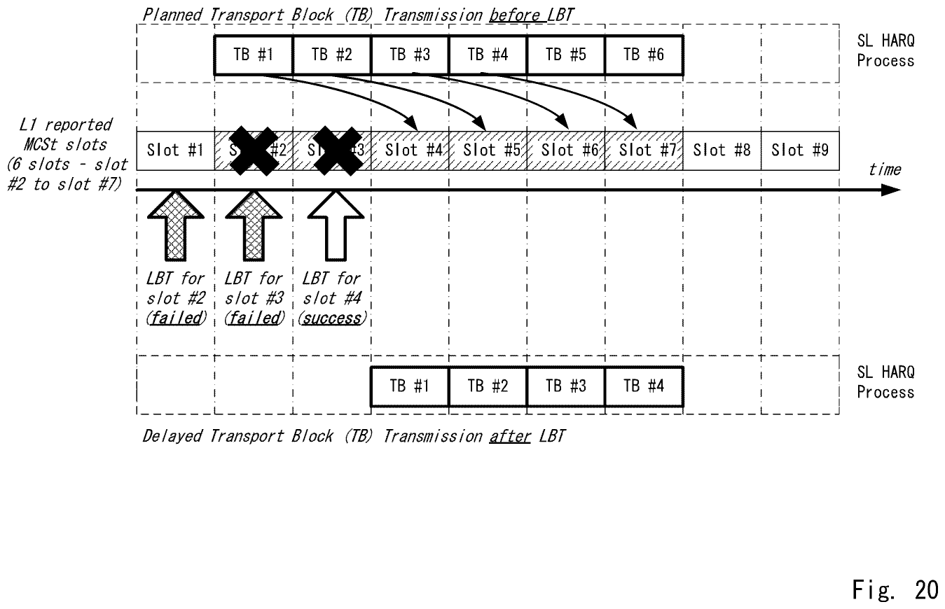

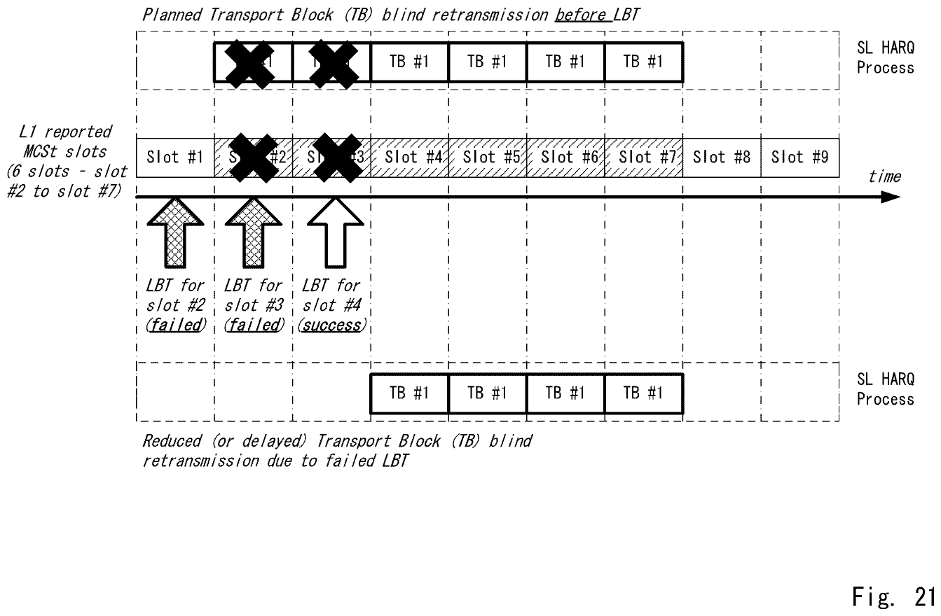

FIG. 20 and FIG. 21 each illustrate a respective example of how TB (re)transmission may be affected by one or more LBT failures within the MCSt slot group.

In the example of FIG. 20, the MAC layer has planned to transmit a plurality of different TBs (in this example six TBs) independently in the slots of the MCSt slot group (slots #2 to #7) with a different respective TB (in the example TB #1 to TB #6) being transmitted in each slot. However, LBT failures occur for transmissions in slot #2 and slot #3. Accordingly, transmission the MAC layer adjusts the planned transmission of one or more TBs to take account of one or more slots of the MCSt slot group within which LBT failure occurred (e.g., as described for step S1916 of FIG. 19) to delay transmission of the earlier TBs (in the example TB #1 to TB #4) until later slots of the MCSt slot group (slots #4 to #7). Later TBs are dropped from transmission within the current MCSt slot group (and may be subject to delayed transmission in newly selected (MCSt) resources).

In the example of FIG. 21, the MAC layer has planned to transmit a single TB (TB #1) in the first slot (slot #2) of the MCSt slot group (slots #2 to #7) and to blindly retransmit the same TB in each slot remaining of the MCSt slot group. However, LBT failures occur for transmissions in slot #2 and slot #3. Accordingly, transmission the MAC layer adjusts the planned transmission/retransmission of the TB to take account of one or more slots of the MCSt slot group within which LBT failure occurred (e.g., as described for step S1916 of FIG. 19) to reduce the planned number of blind retransmissions with later blind retransmissions simply being dropped. Alternatively, some of the blind retransmissions may be delayed (e.g., subject to delayed transmission in newly selected (MCSt) resources).

It will be appreciated that one of the advantages of MCSt transmission, in the context of LBT, is to reduce the occurrence (and hence duration) of type-1 LBT duration and hence increase transmission efficiency.

When the LBT is successful for one or more of the slots (but not all) of the MCSt slot group, and hence at least one or more associated TB (re)transmissions are dropped due to one or more LBT failures (e.g., as a result of delaying one or more earlier (re)transmissions), resource (re)selection can be triggered from the MAC layer to the physical layer to obtain resources for transmission of any such dropped transmissions.

Moreover, to further exploit the advantage of MCSt transmission, when the MAC layer receives an LBT failure report, the MAC layer may instruct the physical layer to reselect consecutive resources (slots) for any such dropped (re)transmissions due to the LBT failure within the MCSt slot group.

### Modifications and Alternatives

Detailed examples have been described above along with a number of variations and alternatives. As those skilled in the art will appreciate, a number of modifications and alternatives can be made to the above examples whilst still benefiting from the disclosure embodied therein.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part, or all of, this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit (CU) and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g., to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a first user equipment (UE), the method comprising:
providing, from a first protocol layer to a second protocol layer, information for use in selecting resources for transmission of data using direct UE-to-UE communication in a plurality of consecutive time resources;
receiving, at the first protocol layer from the second protocol layer, information indicating a set of candidate resources, selected based on the information, for the direct UE-to-UE communication in the plurality of consecutive time resources; and
transmitting the data to a second UE via direct UE-to-UE communication, using at least a subset of the candidate resources, in the plurality of consecutive time resources;
wherein the information includes at least one of:
at least one parameter associated with an autonomous mode of resource selection wherein, in a case where the data includes respective data from each of a plurality of different data sources, each parameter of the at least one parameter is respectively based on a corresponding attribute associated with data from one data source of the plurality of different data sources;
transmission pattern information identifying at least one intended transmission pattern for transmission of the data via direct UE-to-UE communication; and/or size information indicating an estimated total size of data to be transmitted, wherein the estimated total size is based both on an initial transmission of the data and any intended retransmission of the data.

### (Supplementary Note 2)

The method according to supplementary note 1, wherein, in the case where the information includes at least one parameter, the at least one parameter includes a priority parameter indicating a second protocol layer priority.

### (Supplementary Note 3)

The method according to supplementary note 2, wherein, in the case where the data includes respective data from each of a plurality of different data sources, the priority parameter indicating the second protocol layer priority is based on a corresponding priority related attribute associated with data from a data source, of the plurality of different data sources, for which an associated priority is highest.

### (Supplementary Note 4)

The method according to supplementary note 3, wherein the corresponding priority related attribute associated with data from a data source is a channel access priority class (CAPC) and the priority parameter is based on the CAPC associated with the data source, of the plurality of different data sources, for which the associated CAPC is lowest.

### (Supplementary Note 5)

The method according to any preceding supplementary note, wherein, in the case where the information includes at least one parameter, the at least one parameter includes a packet delay budget (PDB) parameter indicating a remaining PDB.

### (Supplementary Note 6)

The method according to supplementary note 5, wherein, in the case where the data includes respective data from each of a plurality of different data sources, the PDB parameter is based on a corresponding PDB related attribute associated with data from a data source, of the plurality of different data sources, for which a remaining PDB is lowest.

### (Supplementary Note 7)

The method according to any preceding supplementary note, wherein, in the case where the data includes respective data from each of a plurality of different data sources, the plurality of data sources include at least one direct UE-to-UE media access control (MAC) control element (CE).

### (Supplementary Note 8)

The method according to any preceding supplementary note, wherein, in the case where the data includes respective data from each of a plurality of different data sources, the plurality of data sources include at least one direct UE-to-UE logical channel (LCH).

### (Supplementary Note 9)

The method according to any preceding supplementary note, wherein, in the case where the data includes more data than can be transmitted using the set of candidate resources, the method further comprises the first protocol layer triggering the second protocol layer to perform a further selection of resources for transmission of at least some of the data.

### (Supplementary Note 10)

The method according to any preceding supplementary note, wherein, in the case where the set of candidate resources includes more resources than are necessary for transmission of the data, the method further comprises dropping at least a subset of resources that are not required for transmission of the data.

### (Supplementary Note 11)

The method according to any one of supplementary notes 1 to 10, wherein, in the case where the set of candidate resources includes more resources than are necessary for transmission of the data, the method further comprises performing a logical channel prioritisation (LCP) procedure for further transmission of the data, or further data, to at least one further UE via direct UE-to-UE communication, using at least a subset of resources that are not required for transmission of the data to the second UE.

### (Supplementary Note 12)

The method according to any preceding supplementary note, wherein, in the case where the information includes transmission pattern information, the transmission pattern information includes at least one of:
an indication of a number of transport blocks (TBs) for transmission of the data;
an indication of a hybrid automatic repeat request (HARQ) transmission mechanism; and/or
   a number of slots to be occupied for blind retransmission.

### (Supplementary Note 13)

The method according to supplementary note 12, wherein, in the case where the transmission pattern information includes an indication of the HARQ transmission mechanism, indication of the HARQ transmission mechanism indicates at least one of:
whether the HARQ transmission mechanism is feedback based or blind retransmission based;
a number of the direct UE-to-UE HARQ processes to be used for intended HARQ transmission; and/or
   a number of blind retransmissions for at least one TB.

### (Supplementary Note 14)

The method according to any preceding supplementary note, wherein the data is transmitted to the second UE, in a plurality of different transport blocks (TBs), using a common hybrid automatic repeat request (HARQ) process, and each TB is transmitted using a different respective time resource of the plurality of consecutive time resources.

### (Supplementary Note 15)

The method according to any one of supplementary notes 1 to 13, wherein the data is transmitted to the second UE, in at least one transport block (TB), using a common hybrid automatic repeat request (HARQ) process, and the at least one TB is transmitted using more than one time resource of the plurality of consecutive time resources.

### (Supplementary Note 16)

The method according to any one of supplementary notes 1 to 13, wherein the data is transmitted to the second UE, in at least one transport block (TB), using a common hybrid automatic repeat request (HARQ) process, and the at least one TB is transmitted in a first time resource of the plurality of consecutive time resources and then retransmitted in at least one further time resource of the plurality of consecutive time resources.

### (Supplementary Note 17)

The method according to supplementary note 16, wherein the method further comprises providing, from the first protocol layer to the second protocol layer, an indication of at least one of a redundancy version, and/or time resources to be used, for transmission and/or each retransmission of the TB.

### (Supplementary Note 18)

The method according to any one of supplementary notes 1 to 13, wherein the data is transmitted to the second UE, in a single transport block (TB), using a hybrid automatic repeat request (HARQ) process, and the single TB is transmitted using at least one time resource of the plurality of consecutive time resources.

### (Supplementary Note 19)

The method according to supplementary note 18, the method further comprises receiving at least one of HARQ feedback and/or a data transmission, from the second UE, in at least one other time resource of the plurality of consecutive time resources.

### (Supplementary Note 20)

The method according to supplementary note 19, wherein the at least one other time resource forms at least part of a shared channel occupancy time (COT).

### (Supplementary Note 21)

The method according to supplementary note 20, wherein the method further comprises transmitting to the second UE, COT sharing information indicating the at least one other time resource.

### (Supplementary Note 22)

The method according to any one of supplementary notes 1 to 13, wherein the data is transmitted to the second UE, in a plurality of transport blocks (TBs), and each TB is transmitted using a different respective hybrid automatic repeat request (HARQ) process.

### (Supplementary Note 23)

The method according to supplementary note 22, wherein each TB is respectively transmitted in a different time resource of the plurality of consecutive time resources.

### (Supplementary Note 24)

The method according to supplementary note 22 or 23, wherein each TB respectively carries data having the same priority.

### (Supplementary Note 25)

The method according to supplementary note 22, 23, or 24, wherein the data is transmitted using a feedback based HARQ retransmission mechanism.

### (Supplementary Note 26)

The method according to supplementary note 22, 23, or 24, wherein the data is transmitted using a blind retransmission based HARQ retransmission mechanism, and each TB is respectively retransmitted in a different time resource of the plurality of consecutive time resources.

### (Supplementary Note 27)

The method according to supplementary note 26, wherein a first TB of the plurality of TBs is transmitted and blindly retransmitted in the plurality of consecutive time resources, in an interleaved manner with transmission and blind retransmission of a second TB of the plurality of TBs.

### (Supplementary Note 28)

The method according to supplementary note 26, wherein a first TB of the plurality of TBs is transmitted and blindly retransmitted in consecutive time resources of the plurality of consecutive time resources, and a second TB of the plurality of TBs is transmitted and blindly retransmitted in consecutive time resources of the plurality of consecutive time resources.

### (Supplementary Note 29)

The method according to any preceding supplementary note, wherein the first protocol layer is a media access control (MAC) layer.

### (Supplementary Note 30)

The method according to any preceding supplementary note, wherein the second protocol layer is a physical (PHY/L1) layer.

### (Supplementary Note 31)

A method performed by a first user equipment (UE), the method comprising:
receiving, at a first protocol layer from a second protocol layer, information indicating a set of candidate resources for transmission of data using direct UE-to-UE communication in a plurality of consecutive time resources; and
transmitting the data to a second UE via direct UE-to-UE communication, using at least a subset of the candidate resources, in the plurality of consecutive time resources;
   wherein, in the case where the data includes more data than can be transmitted using the set of candidate resources, the first protocol layer triggers the second protocol layer to perform a further selection of resources for transmission of at least some of the data; and
   wherein, in the case where the set of candidate resources includes more resources than are necessary for transmission of the data, the method further comprises:
   dropping at least a subset of resources that are not required for transmission of the data; and/or
performing a logical channel prioritisation (LCP) procedure for further transmission of the data, or further data, to at least one further UE via direct UE-to-UE communication, using at least a subset of resources that are not required for transmission of the data to the second UE.

### (Supplementary Note 32)

The method according to supplementary note 31, wherein the at least one further UE is selected as at least one destination UE for the further transmission regardless of whether or not a priority associated with the at least one further UE is higher than a priority associated with another potential destination UE.

### (Supplementary Note 33)

A method performed by a first user equipment (UE), the method comprising:
receiving, at a first protocol layer from a second protocol layer, information indicating a set of candidate resources for transmission of data using direct UE-to-UE communication in a plurality of consecutive time resources;
performing a respective listen-before-talk (LBT) for each time resource of the plurality of consecutive time resources in turn until: a result of an LBT, for a corresponding time resource of the plurality of consecutive time resources, indicates transmission of the data can start in that corresponding time resource; or
the respective LBT fails in every time resource of the plurality of consecutive time resources; and
in a case where at least one LBT fails for a corresponding time resource of the plurality of consecutive time resources, providing at least one LBT failure indication from the second protocol layer to the first protocol layer;
wherein the at least one LBT failure indication comprises:
a single LBT failure indication that is provided in a case that the respective LBT fails in every time resource of the plurality of consecutive time resources;
a respective LBT failure indication that is provided for each LBT that fails for a corresponding time resource of the plurality of consecutive time resources; or
an LBT failure indication that identifies at least one time resource of the plurality of consecutive time resources for which LBT has failed.

### (Supplementary Note 34)

The method according to supplementary note 33, wherein, on receipt of the at least one LBT failure indication from the second protocol layer, the first protocol layer adapts a planned transmission or retransmission of the data based on the at least one LBT failure indication from the second protocol layer.

### (Supplementary Note 35)

A method performed by a first user equipment (UE), the method comprising:
receiving, at a first protocol layer from a second protocol layer, information indicating a set of candidate resources for transmission of existing data using direct UE-to-UE communication in a plurality of consecutive time resources; and
transmitting the existing data to a second UE via direct UE-to-UE communication, in at least one transport block (TB), using at least a subset of the candidate resources, in the plurality of consecutive time resources;
wherein, in a case where the existing data includes a plurality of different data each different data having a different respective priority level of a plurality of possible priority levels:
the plurality of different data having the different priority levels is included in the at least one TB regardless of whether the same TB includes different data having different respective priority levels;
the plurality of different data having the different priority levels is included in a plurality of TBs in a manner that ensures that each TB includes data having a common priority level; or
the plurality of different data having the different priority levels is included in the at least one TB in a manner that ensures that each TB only includes data having a priority level within a specific range of priority levels.

### (Supplementary Note 36)

The method according to supplementary note 35, wherein, in a case where a plurality of different data having the different priority levels is included in the at least one TB regardless of whether the same TB includes different data having different respective priority levels, and the UE has new data for transmission before transmission of all the existing data has completed, the UE waits to transmit the new data, until the existing data has been transmitted, regardless of whether or not the new data has a higher priority level than the existing data.

### (Supplementary Note 37)

The method according to supplementary note 35, wherein, in a case where a plurality of different data having the different priority levels is included in the plurality of TBs in a manner that ensures that each TB includes data having a common priority level, and the UE has new data for transmission before transmission of all the existing data has completed, the UE delays transmission of at least one untransmitted TB including existing data that has a lower priority level than the new data, and transmits the new data in preference to that at least one untransmitted TB.

### (Supplementary Note 38)

The method according to supplementary note 35, wherein, in a case where a plurality of different data having the different priority levels is included in the at least one TB in a manner that ensures that each TB only includes data having a priority level within the specific range of priority levels, and the UE has new data that has a higher priority level than specific range of priority levels for transmission before transmission of all the existing data has completed, the UE delays transmission of at least one untransmitted TB including existing data that has a priority level within the specific range of priority levels, and transmits the new data in preference to that to that at least one untransmitted TB.

### (Supplementary Note 39)

The method according to any one of supplementary notes 35 to 38, wherein each priority level is associated with a different respective channel access priority class (CAPC), and a lower CAPC corresponds to a higher priority level.

### (Supplementary Note 40)

A first user equipment (UE) comprising:
means for providing, from a first protocol layer to a second protocol layer, information for use in selecting resources for transmission of data using direct UE-to-UE communication in a plurality of consecutive time resources;
means for receiving, at the first protocol layer from the second protocol layer, information indicating a set of candidate resources, selected based on the information, for the direct UE-to-UE communication in the plurality of consecutive time resources; and
means for transmitting the data to a second UE via direct UE-to-UE communication, using at least a subset of the candidate resources, in the plurality of consecutive time resources;
wherein the information includes at least one of:
at least one parameter associated with an autonomous mode of resource selection wherein, in a case where the data includes respective data from each of a plurality of different data sources, each parameter of the at least one parameter is respectively based on a corresponding attribute associated with data from one data source of the plurality of different data sources;
transmission pattern information identifying at least one intended transmission pattern for transmission of the data via direct UE-to-UE communication; and/or size information indicating an estimated total size of data to be transmitted, wherein the estimated total size is based both on an initial transmission of the data and any intended retransmission of the data.

### (Supplementary Note 41)

A first user equipment (UE) comprising:
means for receiving, at a first protocol layer from a second protocol layer, information indicating a set of candidate resources for transmission of data using direct UE-to-UE communication in a plurality of consecutive time resources; and
means for transmitting the data to a second UE via direct UE-to-UE communication, using at least a subset of the candidate resources, in the plurality of consecutive time resources;
   wherein the first protocol layer is configured to trigger, in the case where the data includes more data than can be transmitted using the set of candidate resources, the second protocol layer to perform a further selection of resources for transmission of at least some of the data; and
   wherein, in the case where the set of candidate resources includes more resources than are necessary for transmission of the data, the UE is further configured to:
drop at least a subset of resources that are not required for transmission of the data; and/or
perform a logical channel prioritisation (LCP) procedure for further transmission of the data, or further data, to at least one further UE via direct UE-to-UE communication, using at least a subset of resources that are not required for transmission of the data to the second UE.

### (Supplementary Note 42)

A first user equipment (UE) comprising:
means for receiving, at a first protocol layer from a second protocol layer, information indicating a set of candidate resources for transmission of data using direct UE-to-UE communication in a plurality of consecutive time resources;
means for performing a respective listen-before-talk (LBT) for each time resource of the plurality of consecutive time resources in turn until: a result of an LBT, for a corresponding time resource of the plurality of consecutive time resources, indicates transmission of the data can start in that corresponding time resource; or
the respective LBT fails in every time resource of the plurality of consecutive time resources; and
means for providing, in a case where at least one LBT fails for a corresponding time resource of the plurality of consecutive time resources, at least one LBT failure indication from the second protocol layer to the first protocol layer;
wherein the at least one LBT failure indication comprises:
a single LBT failure indication that is provided in a case that the respective LBT fails in every time resource of the plurality of consecutive time resources;
a respective LBT failure indication that is provided for each LBT that fails for a corresponding time resource of the plurality of consecutive time resources; or
an LBT failure indication that identifies at least one time resource of the plurality of consecutive time resources for which LBT has failed.

### (Supplementary Note 43)

A first user equipment (UE) comprising:
means for receiving, at a first protocol layer from a second protocol layer, information indicating a set of candidate resources for transmission of existing data using direct UE-to-UE communication in a plurality of consecutive time resources; and
means for transmitting the existing data to a second UE via direct UE-to-UE communication, in at least one transport block (TB), using at least a subset of the candidate resources, in the plurality of consecutive time resources;
wherein, in a case where the existing data includes a plurality of different data each different data having a different respective priority level of a plurality of possible priority levels:
the plurality of different data having the different priority levels is included in the at least one TB regardless of whether the same TB includes different data having different respective priority levels;
the plurality of different data having the different priority levels is included in a plurality of TBs in a manner that ensures that each TB includes data having a common priority level; or
the plurality of different data having the different priority levels is included in the at least one TB in a manner that ensures that each TB only includes data having a priority level within a specific range of priority levels.

This application is based upon and claims the benefit of priority from Great Britain Patent Application No. 2307042.8, filed on May 11, 2023, the disclosure of which is incorporated herein in its entirety by reference.

### REFERENCE SIGNS LIST

1 COMMUNICATION SYSTEM
3 USER EQUIPMENT
5 BASE STATION
7 CORE NETWORK
9 CELL
10 CONTROL PLANE FUNCTIONS
11 USER PLANE FUNCTIONS
20 EXTERNAL DATA NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
45 DIRECT COMMUNICATIONS MODULE
51 TRANSCEIVER CIRCUIT
53 ANTENNA
55 CORE NETWORK INTERFACE
57 CONTROLLER
59 MEMORY
51 OPERATING SYSTEM
53 COMMUNICATIONS CONTROL MODULE
55 DIRECT COMMUNICATIONS MANAGEMENT MODULE

What is claimed is:

1-32. (canceled)

33. A method performed by a first mobile device, the method comprising:
determining whether a data unit is not transmitted in any of resources for the data unit that are associated with a process of sidelink communication between the first mobile device and a second mobile device for multiple consecutive time resources transmission due to listen before talk (LBT) failure; and
in a case where the data unit is not transmitted in any of resources for the data unit that are associated with the process of sidelink communication between the first mobile device and the second mobile device for the multiple consecutive time resources transmission, triggering a selection procedure of resources for the data unit that are associated with the process of sidelink communication for the multiple consecutive time resources transmission, based on a highest priority of a corresponding logical channel.

34. The method according to claim 33, wherein
the selection procedure is performed based on at least one of:
a hybrid automatic repeat request (HARQ) transmission mechanism; or
a number of slots for the multiple consecutive time resources transmission.

35. The method according to claim 34, wherein
the HARQ transmission mechanism includes at least one of:
whether the HARQ transmission mechanism is feedback based or blind retransmission based;
a number of sidelink HARQ processes to be used for HARQ transmission; or
a number of sidelink HARQ retransmissions.

36. The method according to claim 33, wherein
the selection procedure includes selecting resources based on a remaining packet delay budget (PDB).

37. The method according to claim 33, wherein
the selection procedure includes selecting resources based on a channel access priority class (CAPC) level of the data unit.

38. The method according to claim 33, wherein
the selection procedure includes selecting resources having at least one of a Medium Access Control (MAC) Control Element (CE) and a logical channel with the highest priority.

39. The method according to claim 33, wherein
the selection procedure includes selecting resources based on a parameter associated with an autonomous mode of resource selection.

40. The method according to claim 33, wherein
the selection procedure includes selecting resources based on information identifying at least one transmission pattern for transmission of the data unit via the sidelink communication.

41. The method according to claim 33, wherein
the selection procedure includes selecting resources based on information indicating a size of the data unit.

42. The method according to claim 33, further comprising:
performing a logical channel prioritisation (LCP) procedure for transmission of the data unit or further data unit, to a third mobile device via sidelink communication, using resources for the multiple consecutive time resources transmission, the resources being not required for transmission of the data unit to the second mobile device.

43. The method according to claim 33, wherein
the data unit is transmitted in a plurality of transport blocks (TBs), using a common hybrid automatic repeat request (HARQ) process, and
each of the plurality of the TBs is transmitted using a respective time resource of the resources for the multiple consecutive time resources transmission.

44. The method according to claim 33, wherein
the data unit is transmitted in at least one transport block (TB), using a common hybrid automatic repeat request (HARQ) process, and
the at least one TB is transmitted using more than one time resource of the resources for the multiple consecutive time resources transmission.

45. The method according to claim 33, wherein
the data unit is transmitted in at least one transport block (TB), using a common hybrid automatic repeat request (HARQ) process, and
the at least one TB is transmitted in a first time resource of the resources for the multiple consecutive time resources transmission and retransmitted in at least one further time resource of the resources for the multiple consecutive time resources transmission.

46. The method according to claim 45, further comprising:
the at least one TB is transmitted based on at least one of:
a redundancy version, or
resources to be used,
for transmission and/or each retransmission of each of the at least one TB.

47. The method according to claim 33, wherein
the data unit is transmitted in a single transport block (TB), using a hybrid automatic repeat request (HARQ) process, and
the single TB is transmitted using one of the resources for the multiple consecutive time resources transmission.

48. The method according to claim 46, further comprising:
receiving, from the second mobile device, at least one of:
HARQ feedback, or
a data transmission,
in at least one other resource for the multiple consecutive time resources transmission.

49. The method according to claim 48, wherein
the at least one other resource forms at least part of a shared channel occupancy time (COT).

50. The method according to claim 33, wherein
the data unit is transmitted in a plurality of transport blocks (TBs), and
each of the plurality of the TBs is transmitted using a respective hybrid automatic repeat request (HARQ) process.

51. The method according to claim 33, further comprising:
using the highest channel access priority class (CAPC) value among a respective CAPC values of a plurality of consecutive slots for the process of sidelink communication between the first mobile device and the second mobile device for multiple consecutive time resources transmission.

52. A first mobile device comprising:
at least one memory configured to store instructions; and
at least one processor configured to execute the instructions to:
determine whether a data unit is not transmitted in any of resources for the data unit that are associated with a process of sidelink communication between the first mobile device and a second mobile device for multiple consecutive time resources transmission due to listen before talk (LBT) failure; and
trigger a selection procedure of resources for the data unit that are associated with the process of sidelink communication for the multiple consecutive time resources transmission, in a case where the data unit is not transmitted in any of resources for the data unit that are associated with the process of sidelink communication between the first mobile device and the second mobile device for the multiple consecutive time resources transmission, based on a highest priority of a corresponding logical channel.
